(19) United States
(12) Patent Application Publication
(10) Pub. No.: US 2009/0087616 A1
(43) Pub. Date: Apr. 2, 2009

(54) COATINGS FOR GLASS REINFORCED FACED GYPSUM BOARD

(76) Inventors: Mark E. HENNIS, Clearwater, FL (US); Christopher J. Sanders, Safety Harbor, FL (US); Michael P. Fahey, St. Petersburg, FL (US); Gregory L. Wascomb, Pickerington, OH (US); Robert J. Hauber, Tampa, FL (US); Gerald D. Boydston, Cody, WY (US)

Correspondence Address: VANGELIS ECONOMOU;C/O IPHORGAN LTD, 1130 LAKE COOK ROAD, SUITE 2400, BUFALLO GROVE, IL, 60089, US

(21) Appl. No.: 12/329,998

(22) Filed: Dec. 8, 2008

Related U.S. Application Data
(63) Continuation-in-part of application No. 11/078,518, filed on Mar. 11, 2005.
Application No. 11/078,518 is a continuation-in-part of application No. 10/164,108, filed on Jun. 4, 2002, now Pat. No. 6,866,492.
Application No. 10/164,108 is a continuation-in-part of application No. 09/875,733, filed on Jun. 6, 2001, now Pat. No. 6,524,679.
(60) Provisional application No. 61/093,167, filed on Aug. 29, 2008.

(51) Int. Cl. B32B 3/00; B05D 3/00

(52) U.S. Cl. 428/141; 427/372.2; 428/195.1; 428/201

(57) ABSTRACT

A coating method for gypsum board having a surface gypsum layer in which a polymer additive has been entrained including forming a gypsum board including the polymer additive entrained in a surface layer, application of a preferably acrylic primary coating, curing and drying the gypsum board, passing the gypsum board through a first roll coater wherein a second fluid coating is deposited over the primary layer of the dried, coated gypsum board in which the polymer additive has been entrained, the coating then being dried and cured, wherein the coating material of the primary coating forms a chemical bond with the polymer additive entrained in the surface layer of the gypsum board and the polymer of the primary coating forms a chemical bond with the second fluid coating. A coating material which can form copolymer bonds with the second coating is then deposited on the second coating and then dried and cured, resulting in coated gypsum board having a low surface tension surface that is essentially impermeable to water and vapor or moisture penetration.

### REFERENCE TO RELATED APPLICATIONS

This is a Continuation-in-Part of application Ser. No. 11/078,518, filed on Mar. 11, 2005, which is a Continuation-in-Part of application Ser. No. 10/164,108, filed on Jun. 4, 2002, and issued on Mar. 15, 2005 as U.S. Pat. No. 6,866,492, which is a Continuation-in-Part of application Ser. No. 09/875,733 filed on Jun. 6, 2001, and issued on Feb. 25, 2003 as U.S. Pat. No. 6,524,679, the disclosures of all these patents and applications being incorporated herein by reference, and also relies for priority on Provisional Application No. 61/093,167 filed on Aug. 29, 2008, the disclosure of which incorporated herein by reference, where appropriate.

### BACKGROUND OF THE INVENTION

1. Field of the Invention

This invention relates generally to building components, and more particularly, relates to coatings and finishing of glass-reinforced gypsum board in building construction for use as a tile backer in wet environments.

2. Background Art

Gypsum board, and its production, has received attention in the building industry, and especially for providing an easily worked building material the consistency of which is available for general construction use. Desirable characteristics for gypsum board also include a smooth working surface, consistent thickness throughout, and the ability to provide finishing enhancements, such as paint or other protective coverings, thereon.

Recent developments in the manufacture of gypsum board have also added to the durability and versatility of the uses to which gypsum boards may be put.

A particularly useful development in the building board field is known as glass reinforced gypsum (GRG) board. GRG board and its manufacture are well known in the construction industry, and it is described in commonly owned U.S. Pat. No. 4,378,405, incorporated herein by reference. Products made according to U.S. Pat. No. 4,378,405 are sold by the common assignee, BPB, Ltd., under the name “Glasroc.” GRG board, of generally conventional construction, is comprised of a gypsum core having a non-woven glass mat immediately below one or both principal surfaces. In the aforementioned U.S. Pat. No. 4,378,405, the mat is introduced into the core by vibrating the core slurry, which either overlays or underlays the mat, to cause the slurry to pass through the mat, so that the surface layer or layers of gypsum are integral with the core. GRG boards are considered stronger than conventional paper boards and exhibit superior fire resistance.

Manufacture of GRG boards compromises the need to provide strength by employing non-woven glass fiber mat of relatively low diameter (for example, 13.0 μm (0.005 inch)) fibers with the need to ensure efficient exhaustion of air through a mat from the gypsum slurry from which the board is formed. This is a particular problem at the edge margins of the board where the bottom mat is brought up and onto the upper surface of the board to define the edges of the uncut board. Inefficient exhaustion of air in this region can lead to voids in the edge margins of the cut boards, reducing the edge strength of the boards.

The problem of voids in the edge margins has been dealt with by increasing the fiber diameter of the mat, particularly the bottom mat (to, for example, 16 μm (0.0065 inch)), allowing easier exhaustion of air and penetration of gypsum slurry, but which consequently may result in a reduction of board strength.

Additional compromises in optimization between concerns of cost and of effectiveness arise from the amount of penetration of slurry through the glass mat fibers. In order to ensure that slurry penetrates essentially throughout the surface of the glass mat fibers, aforementioned U.S. Pat. No. 4,378,405 teaches the use of vibration, for example, by vibrators, as disclosed therein. The vibrators vibrate the glass mat and slurry composition to ensure that the “slurry penetrates through the fabric” of the glass mat fibers to form a thin continuous film on the outer surface of the glass mat fibers.

It has been found desirable to form a thin film of slurry on the outer face surface of the glass mat, to avoid exposed fibers of glass, and so to present a smooth working gypsum board surface that can be handled by construction workers without necessitating protective covering of the hands. It has been found that when gypsum boards with exposed glass fibers, such as those taught, for example in U.S. Pat. Nos. 4,647,496; 4,810,659; 5,371,989; 5,148,645; 5,319,900; and 5,704,179, are handled at a construction site by workers, exposed glass fibers penetrate the skin of uncovered hands, and this generally results in worker discomfort. It has been further found that later finishing, e.g., painting, of a smooth gypsum board surface is more desirable because the need for additional pre-finishing steps, such as priming, etc., may be minimized.

Commonly-owned U.S. Pat. No. 6,524,679, referenced above as the parent application on which this invention claims priority, has been proposed as an all-purpose building material for use as internal walls of a building. The teaching of U.S. Pat. No. 6,524,679 are incorporated by reference herein. The gypsum board resulting from practice of the teaching therein provides a board having advantages over prior art boards, as described. However, in order for those gypsum boards to be utilizable in exterior sheathing, additional features have been developed for use therewith as more fully described below.

Manufacturing facilities for the production of gypsum board, whether or not glass mats are utilized for the structural facings, are capital intensive in the costs of space, equipment and in the down time during which a gypsum board production line is reconfigured. For production of a variety of gypsum board products, for example, standard paper faced gypsum board, glass mat backed board, etc., down time of the production line represents a significant cost in the delay of production of gypsum board and in time wasted by production workers who remain idle.

It has been found advantageous to provide a gypsum board production facility that is easily modified, without long periods of shutting down production, when a production line is being switched from the production of one type of gypsum board to another.

Another consideration in establishing a gypsum board production line arises from the long time required for gypsum slurry in liquid form to be formed, and to set up in a process known as hydration, then to be cut, then processed and dried to remove the water from the set gypsum. To perform the complete process takes a predetermined amount of time, which is an uncompromising restraint on the amount of gypsum board that can be processed on a gypsum board line.

To accommodate these concerns, standard gypsum board lines have been increased in length so that sufficient time elapses as the gypsum travels along the line to permit production, hydration and curing of the gypsum boards, while simultaneously increasing the output of gypsum board being produced on a single board line.

It is important for the board line to run at a sufficient speed, meanwhile maintaining the desired output of gypsum board, while also retaining the efficient operation and consistent quality of the gypsum board produced. Thus, the continuous feed of unset gypsum board is preferably matched with the speed of the conveyor belt as it takes up the gypsum board for the hydration and curing steps occurring down the stream from the gypsum board formation station. Efficient processes for gypsum board must use a production line, therefore, that has a length dependent on the rate of desired production, so that the gypsum board becomes fully hydrated and cured at the end of the conveyor belt run.

Additional compromises in optimization between concerns of cost and effectiveness arise from the amount of penetration of slurry through the mineral or glass mat fibers when these are utilized as facing materials. In order to ensure that unset gypsum slurry penetrates essentially throughout the surface of the glass mat fibers, aforementioned U.S. Pat. No. 4,378,405 teaches the use of vibration, for example, by means of vibrators, as disclosed therein. The vibrators vibrate the glass mat and slurry composition to ensure that the “slurry penetrates through the fabric” of the glass mat fibers, to form a thin continuous film on the outer surface of the glass mat fibers.

It has been found desirable to form a thin film of slurry on the outer face surface of the glass mat, to avoid exposed fibers of glass, so as to present a smooth working surface of the gypsum board that can be handled without protective covering of the hands. It has been found that when gypsum boards with exposed glass fibers, such as those taught, for example, in U.S. Pat. Nos. 4,647,496; 4,810,569; 5,371,989; 5,148,645, 5,319,900; and 5,704,179, are handled at a construction site by workers; glass fibers penetrate the skin of uncovered hands and result in discomfort. It has been further found that further finishing, e.g., painting, laying tile, etc., on a smooth gypsum board surface, is made easier because the need for additional prefinishing steps, such as priming, roughening, etc., may be minimized.

Although the smooth surface of gypsum boards provided by the process utilized in aforementioned U.S. Pat. No. 4,378,405 has been found adequate, it is desirable that the operation of the gypsum board line be run quickly and with a more efficient use of available resources. Although the smooth surface of gypsum boards provided by the process utilized in aforementioned U.S. Pat. No. 4,378,405 is adequate to achieve the stated purposes, the process of manufacture, and especially the vibration steps, tend to slow down board production operation and to render the process useful only for specialized applications for which a customer is willing and able to contend with delays in production and in the consequential costs. Moreover, it is not possible to utilize the process of making GRG gypsum boards as taught by U.S. Pat. No. 4,378,405 in a standard gypsum board line because that process requires structural changes to the board production line, which may take time and capital to effectuate.

Another consideration that must be accommodated in terms of timing is the desirability of the gypsum slurry to penetrate through the glass fiber mat so as to produce a clean, smooth surface on the faces of the gypsum board, without unexposed glass fibers extending along the surface. The need to allow sufficient time for the gypsum slurry to penetrate through the mat also restricts the speed of the gypsum board manufacturing line.

It has been found desirable to provide a gypsum board and manufacturing process thereof which can be manufactured at relatively high speed, has high structural integrity and strength by virtue of using a mat of relatively low diameter fibers, and may include in a face coating a polymeric additive material providing a surface ideal for further finishing of the gypsum board. The production process for making gypsum board products according to this invention is capable of quick and efficient change over, for changing of the gypsum board production line, for example, from a board line producing paper faced gypsum board to one producing one or more gypsum boards described herein as embodiments of the gypsum boards according to the present invention.

Coatings on surfaces of a gypsum or cementitious board, both on paper faced boards and on glass reinforced gypsum boards, have been known and are the subject of research in the industry. For example, U.S. Pat. Nos. 7,238,402; 7,208,225; 4,948,647; 6,406,779; 6,740,395; 6,770,354; 7,049,251; 6,303,229; 6,254,817; 3,824,147 provide for different methods of coating and different coated products, but many of these share certain deficiencies, including complexity of the manufacturing processes, use of hazardous or prohibited materials, delamination of the coatings from the gypsum board surfaces and other characteristics that make the products unappealing to the general trade. Others have suggested that the glass fiber reinforcement be coated with a polymer prior to its introduction into the gypsum layers, for example, in U.S. Pat. Nos. 5,397,631; 5,552,187; 6,770,354 and 7,238,402. However, it is known that products made in accordance with these patents are also subject to delamination or peeling of the coatings and that the fiber mat is expensive and hard to manipulate when it is pre-coated. A number of other issues can also arise, including the surface tension inhibiting the adhesion of other finishing materials, such as Portland cement, onto the surface of the board, or that the amount of coating that is necessary to achieve an acceptable level of performance exceeds the profitability margins for these types of products.

Another consideration for choosing the coating materials is that when a gypsum board product is very permeable, the open time during which the coating permits vapor penetration would be shortened for hydraulic adhesives. In such a case, the moisture in the adhesive would move from the adhesive into the substrate in a short amount of time, thereby not allowing the hydraulic cement to fully cure. The converse, where the product acted as an impermeable vapor retarder, would not permit the thin-set adhesives to dry out, since the water vapor would not move into the substrate.

The present invention can provide an inventive product by utilizing the process according to the present invention and the inventive gypsum board manufacturing facility can provide the capability to quickly change over from a standard plasterboard line, for example, which produces paper backed gypsum boards, to a process utilizing glass mats that become completely covered by a thin film of gypsum, without requiring breakdown and rebuilding of the production line. The production line further may be used to produce an embodiment of the present invention which includes a gypsum board having a surface that is relatively smooth and can be utilized or finished without other preparation, or can have coatings that are very robust in a moist or wet environment but that require a slight film or minimal thickness in the coating to achieve a high degree of surface roughness to provide a base for the physical adhesion of mastic, Portland cement, or other finishing material, whether organic or inorganic.

The present invention, although intended primarily for use as a tile backer in wet or moist environments, such as showers, baths or kitchen sink areas, further may provide a gypsum board providing a weather resistive barrier for use as an exterior wall surface. Weather resistive barriers may be provided on exterior wall surfaces to protect building materials from a variety of weather conditions, including the effects of wind, bulk water, in the form of precipitation, thermal extremes and ultraviolet and sunlight. The barriers not only prevent direct water damage to building materials by seepage, but also help to control the growth of mold and mildew that may thrive in a moist environment, and which can be detrimental to the health of occupants.

Previously, “green boards” were used to provide a wall surface for the adhesion of tiles in kitchen, shower stall, bathroom or other wet areas of a residential or industrial construction. Green boards are paper faced wall board products that have been modified to include materials or coatings that reduce moisture penetration. Other applications for what is referred to in the industry as bath backer or tile backer, include tiled areas of bathrooms and kitchens, kitchen counter tops and back splashes, gym locker rooms, flooring substrates and swimming pool areas.

More recent building code changes have mandated that phasing out of green board, as it has been recognized that water can wick up paper surfaces even if they have been treated and thereby cause damage to the backing wall board on which tiles are adhered. Once the backing integrity is compromised, the tiles become loose and cause the seal to the wall to be broken, thereby allowing more water ingress and continuing the damage to the wall in an ever accelerating vicious circle that ultimately requires removal and replacement of the complete wallboard behind the tile surfaces. Accordingly, the industry is moving away from green board and toward other alternative means that address the water seepage problem including glass face gypsum (partially embedded), fiber cement, open mesh cement and gypsum wood fiber applications. The present invention addresses the need to formulate an enhanced glass reinforced gypsum board products that are water impervious, are capable of retaining their integrity under the weight of ceramic tiles and also that comply with modern code requirements.

The glass reinforced gypsum boards made in accordance with the teachings of aforementioned U.S. Pat. No. 6,524,679 are utilizable for wet area applications, but nevertheless are not ideally suited therefor because once installed, the gypsum boards do not provide a complete shield and/or an optimal permeability to water vapor so as to permit any accumulated water to be repelled from surface and stop moisture from entering within the walls. Thus the present invention addresses this problem and is provided to further augment the water repellent properties of the glass reinforced gypsum boards by more effectively sealing leak paths and providing a sturdy and essentially waterproof surface that will maintain tile wall integrity.

One significant feature of the present invention is the ability of the gypsum board surface to create a combination chemical and physical bond to any finishing process that is applied to the surface. Moreover, because of the polymer that is embedded in the matrix of the gypsum utilizing the inventive methods described herein, a chemical bond is created by cross-linking between the polymer additive molecules in the dense gypsum layer and the first coating polymer of the finishing application, for example, paint or a coating. Ideally, the cross-linking can be accomplished especially over the dense gypsum layer at the surface of the eGRG board irrespective of the temperature of the coating process, and such a finishing coat should be applicable both before or after the gypsum board has completed drying in a kiln or oven, as has been discussed in aforementioned commonly-owned U.S. Pat. Nos. 6,524,679 and 6,866,492.

A need has developed to provide an efficient and extra dependable universal coating or finishing process that allows the coating to be easily applied, and that is capable of creating a better bond and more durable and weather resistant gypsum board that exceeds standard board parameters. A need exists in the industry for a universal gypsum board platform that can be used across a large variety of applications and product lines, with easily made modifications being in the type, thickness, or other parameters of the coating to provide the desired qualities and characteristics of the product. An easy to modify method and production process for providing coatings that have preferred characteristics, for example, an easily adherent surface that can adhere to a hydrophobic material but is simultaneously hydrophilic enough to permit the passage of water vapor under certain conditions.

### SUMMARY OF THE INVENTION

Accordingly, there is disclosed herein a method of manufacture of gypsum board having inorganic fiber face sheets, and of finishing the gypsum board, the gypsum board having a surface gypsum layer in which a polymer additive has been entrained, comprising forming a gypsum board including the polymer additive entrained in at least one surface layer, depositing a primary coating on the gypsum board surface, curing and drying the gypsum board; passing the gypsum board through a direct roll coater wherein a second coating is deposited over the at least one surface layer of the gypsum board in which the polymer additive has been entrained, wherein the second coating is modified to provide increased surface tension and a rougher surface topology, and wherein the second coating forms a chemical bond with the first coating. In one preferred embodiment, the gypsum board then passes through a second direct roll coater, in which a second coating material that is the same or different from the first coating material is applied on the first coating to produce a double coated board surface so that the second coating forms a chemical bond with the first coating. The primary coating is preferably an acrylic latex. The second coating is preferably an acrylic and is preferably applied off-line from the board formation process line. Subsequent coatings may comprise other polymers, such as a texturizing agent, for example, polypropylene.

In another aspect, the invention comprises a coated gypsum board made in accordance with the above described method, the gypsum board having a surface layer in which a polymer additive has been entrained, further comprising a first coating that includes a chemical bond between the polymer additive entrained in the surface layer of the gypsum board and the coating material which is preselected so as to produce an increased surface tension thereby providing a raised surface having isotropic texture area directional features, whereby the surface contact area of the board is increased to provide an increased chemical and mechanically adhesive surface for attaching tiles.

### BRIEF DESCRIPTION OF THE DRAWINGS

FIG. 1 is a diagrammatical, cross-sectional view of the gypsum board forming station according to the present invention;

FIG. 2 is a detailed, cross-sectional, diagrammatical view of the vibrator sub-assembly shown in FIG. 1;

FIG. 3 is a detailed, cross-sectional, diagrammatical view of FIG. 1, showing the top sheet sub-assembly according to the present invention;

FIG. 4 is a top plan view of the edger flapper bar feature according to the present invention;

FIG. 5 is a side view in detail of the edger flapper bar shown in FIG. 4;

FIG. 6 is a detailed top view of the edger flapper bar feature shown in FIG. 4;

FIG. 7 is a detailed, cross-sectional, diagrammatical view of a gypsum board according to the present invention manufactured utilizing the inventive gypsum board production process and the forming station shown in FIG. 1;

FIG. 8 is a side view of a second embodiment of an edger flapper assembly feature according to the present invention;

FIG. 9 is a top view in detail of the edger flapper bar shown in FIG. 8;

FIG. 10 is a detailed side view of the edger flapper bar feature shown in FIG. 8;

FIG. 11 is a detailed, cross-sectional, diagrammatical view of a gypsum board traveling through the edger bar assembly according to the present invention as shown in FIGS. 8-10.

FIG. 12 illustrates a schematic, diagrammatic elevational view of the gypsum board final forming apparatus according to the present invention;

FIG. 13 illustrates a top diagrammatical view of the gypsum board production and transportation line including the gypsum board final forming apparatus shown in FIG. 12;

FIG. 14 shows in a detail elevational view the final forming apparatus of FIGS. 12 and 13 in greater detail;

FIG. 15 shows a detailed cutaway elevational view of a portion of the final forming apparatus of FIG. 12;

FIG. 16 is a top plan view of the gypsum coating off-line according to the present invention, including the series of novel coating station configuration for providing the desired coating(s) on the gypsum boards;

FIG. 17 is a side view, shown as a schematic diagram, of the coating stations and the intermediate processing points and steps needed to finish the board coatings;

FIG. 18 illustrates a side view of several of the coating stations in the coating line, to indicate the roller coating operation;

FIG. 19 is a detailed, cross-sectional, view, similar to the view of FIG. 7, of a gypsum board according to the present invention manufactured utilizing the inventive gypsum board production process and including acrylic coatings on the top and bottom surfaces and on the machine edge; and

FIG. 20 illustrates in a side view of the coated prior art gypsum board the wetting process of hydrophilic liquids on the board surface;

FIG. 21 illustrates in a side view of the coated inventive gypsum board the wetting process of hydrophilic liquids on the board surface;

FIGS. 22A and 22B illustrate schematically and not to scale the surface texture and specular reflectivity, respectively, of a prior art gypsum board;

FIGS. 23A and 23B illustrate schematically and not to scale the surface texture and specular reflectivity, respectively, of a gypsum board inventive that has been coated with a coating according to the present invention.

### DETAILED DESCRIPTION OF THE PREFERRED EMBODIMENTS

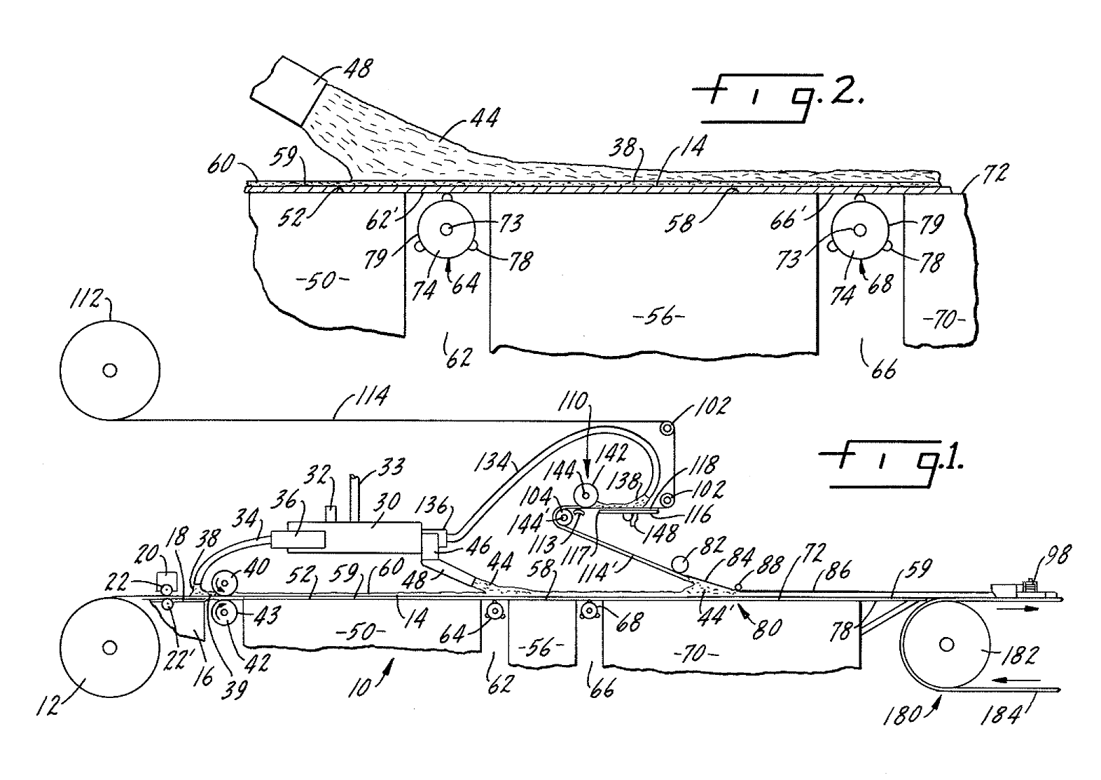

In the diagrammatical, cross-sectional illustration of FIG. 1, the board forming station 10 of an inventive embodiment of the inventive plant is shown. Although illustrated in cross-section, the station 10 is shown diagrammatically to clearly depict the separate elements in relation to each other. Modifications to the arrangement are possible and distances between the separate elements are not to scale for simplicity of illustration, but a pragmatic and efficient arrangement will come to mind to a person having ordinary skill in the art.

The inventive plant 10 comprises a supply roll 12 that provides feed of a continuous sheet of facing material that, in the arrangement shown, defines a bottom-embedded sheet 14. The supply roll 12 may feed out a sheet comprising any conventional material used in gypsum boards, for example, paper or paper board, but for purposes of the present invention, the material of bottom embedded sheet 14 preferably comprises a mat of long inorganic, e.g., glass, fibers which will be more clearly described below with reference to the formation of the inventive gypsum board product, when the inorganic fibers comprise a glasso-glassive fiber, the products being, sometimes referred to herein as glass reinforced gypsum (“GRG”) boards.

The supply roll 12 pays out the continuous bottom embedded sheet 14 over a first forming table 16, having an upwardly facing surface 18, provides a working surface for further processing of the bottom embedded sheet 14. The first forming table 16 also provides a support for creaser wheel assembly 20, disposed athwart the surface 18.

The sheet 14 may be extracted from the supply roll 12 by motion of the sheet being pulled through the board forming station 10 by the belt line, as will be described. The two creaser wheels are vertically disposed within the creaser wheel assembly 20, one set of wheels 22 above the bottom embedded sheet 14 cooperate with a second set of wheels, referred to as the wheel anvil 22′, below the sheet 14. The creaser wheels 22, 22′ rotate on axles and produce partially cut edge creases on the sheet 14 adjacent to each of the longitudinal edges of the bottom-embedded sheet 14. The edge creases are spaced to allow varying fold thicknesses and to cause the edges to turn upwardly so as to retain slurry poured onto the bottom-embedded sheet 14 downstream of the creaser wheel assembly 20, as is described below.

A continuous mixer 30, receives raw materials, i.e. stucco, plaster, gypsum (in powder form), water and other additives, through one or more inlets, one of which inlets 32 is shown in FIG. 1. The mixer 30 provides a mixing capacity that formulates a desirable density of wet gypsum slurry by, for example, rotating a mixing blade (not shown) via a drive shaft 33. Because it is a desirable feature for this invention to produce a multi-layer gypsum board, the mixer 30 may comprise separate mixing chambers (not shown in FIG. 1) for providing separate and different slurry mixtures. A continuous mixer also can be utilized in the course of practicing this invention, and one such mixer is described and illustrated in commonly-owned U.S. Pat. No. 5,908,521, which is incorporated by reference as if fully set forth herein.

Alternatively, and to conserve space, equipment and processing time, the mixing of additives and other modifications to the slurry mixture, for example, introducing air bubbles to the slurry to make it less dense, may be done in-line. For example, additives may be introduced into the gypsum stream by an additive assembly connected to an additive fluid feed that is capable of adding a homogenous stream of additive to the gypsum slurry stream in a transport receptacle following a method, such as that disclosed in commonly owned U.S. patent application Ser. No. 10/968,680, filed on Oct. 19, 2004, and published under Pub. No. 2005/0121131 on Jun. 9, 2005, the disclosure of which is herein incorporated by reference. The additive assembly may comprise, for example, an additive delivery port in fluid communication with the additive fluid feed and a turbulator disposed in-line with the additive fluid feed having a fluid constrictor with an outlet, the fluid constrictor outlet being disposed adjacent or within the gypsum slurry stream being transported through the gypsum slurry transport receptacle before it is deposited onto the fiber face mat.

Referring again to FIG. 1, the continuous mixer 30 provides several outlets for gypsum slurry each having varying desirable characteristics depending on the function of the slurry layer for which any specific outlet is producing gypsum slurry. Each outlet includes an output control for controlling the amount of gypsum slurry permitted to flow through the outlets and into the gypsum board forming plant. The control may be one or more slurry delivery mechanisms, as described in aforementioned U.S. Pat. No. 5,908,521, which incorporate controlled variable delivery speeds so that only the desired amount of gypsum slurry is pumped through the outlets.

As shown in FIG. 1, mixer 30 comprises a first slurry outlet 34, controllable by a control device 36, which allows for the continuous flow of a slurry mixture having desirable characteristics, as described in aforementioned U.S. Pat. No. 5,908,521. In this embodiment, mixer 30 is set to provide two types of slurry. Control device 36 delivers a denser gypsum slurry mixture that is ultimately utilized adjacent the facing of the completed gypsum board, as will be described below.

The end of the slurry outlet 34 extrudes the gypsum slurry directly onto the bottom-embedded sheet 14, which is continuously moving over the surface 18 of forming table 16. Slurry outlet 34 preferably comprises a rubber boot, but other types of outlets may be used, for example, flexible hoses or piping. Preferably, the gypsum slurry 38 is poured onto the upwardly facing surface of the sheet 14 at a position where it is supported by the forming table surface 18, and a predetermined amount of dense gypsum slurry is deposited over the continuously moving sheet 14 so as to coat the internal surface of bottom face sheet 14. It should be noted that this upwardly facing internal surface of sheet 14 is normally provided to be an inner surface of the bottom-embedded sheet 14, and will be embedded inwardly from the board surface when the gypsum board is fully formed. To ensure that the dense gypsum slurry 38 is evenly spread out over the top surface of the bottom face sheet 14, a set of roller wheels 40, 42, also referred to herein as roll coaters 40, 42, are positioned again vertically over and under the sheet 14. The roller coater wheels 40, 42 can rotate in forward or reverse directions.

One advantage and benefit which derives from use of rotating roller coater wheels 40, 42 is that in addition to providing a smooth, evenly spread surface coating over the mat comprising the bottom embedded sheet 14, the dense slurry layer 38 deposited on the inner mat surface is forced, by the top roller wheel 40, to extend through the sheet 14 and to form a structurally integral surface. The surface layer of gypsum slurry 38 may be modified to include additives, such as an engineered polymer, to provide structural strength and load carrying capability to the gypsum board product. As will be described, the optional polymer additive may also present a polymer matrix that provides a water impervious surface having desirable performance characteristics, such as, plastic sheathing, or water repelling, properties so as to expand the possible uses of the gypsum board products to both indoor and outdoor use.

In a preferred embodiment of the invention, the material comprising the bottom-embedded sheet 14 is a mat of randomly aligned mineral, e.g., glass, fibers, having an average fiber diameter of 13-16 μm (0.005-0.0065 inches), and including a binder to hold the glass fibers in the form of a glass fiber mat having a desirable thickness. Such glass fiber mats are known for use in the production of gypsum board, for example, see aforementioned U.S. Pat. No. 4,378,405 and WIPO Publication No. WO9809033 (European Patent No. EP 0 922 146). Use of a mineral fiber mat, which is porous to water generally, provides added structural strength to the gypsum board. The porous nature of the mineral fiber mat also permits gypsum slurry to penetrate through the pores between the mineral fibers and to permeate so as to cover both the top surface and through slurry penetrating the bottom surface of bottom embedded sheet 14 because of slurry penetration. Thus, as the bottom embedded sheet 14 passes through the roll coaters 40, 42, the unset higher density gypsum 38 is coated over the mineral fibers and is forced in the roll coating process to penetrate through the bottom embedded sheet 14 and coat each of its top and bottom surfaces with an unset denser gypsum layer 38. Ideally, the high-density gypsum 38 is forced to penetrate 100% through the glass mat sheet 14, although manufacturing tolerances may permit penetration of approximately 95-98%, which describes a substantial penetration therethrough.

In a preferred form, the roll coaters 40, 42 cause penetration of the unset denser gypsum slurry 38 to coat the bottom surface of the glass mat bottom sheet 14. This bottom surface of the bottom-embedded sheet 14 will ultimately become the embedded surface of the completed gypsum board products. Preferably, the unset gypsum slurry 38 is caused to form a dam 39, which then impregnates a continuous layer of unset gypsum through to the bottom surface of the glass mat 14 to form a dense slurry gypsum layer having a thickness that is in a range from approximately 0.01 to 2.0 mm, as measured from the outermost surface of glass mat 14. Although penetration of the slurry 38 may not result in a continuous layer having a discrete thickness, nevertheless the process preferably will result in each of the glass fibers, comprising the glass fiber mat 14, in being coated on its surface so that very few or no exposed uncoated glass fibers remain.

The speed of rotation of the rollers 40, 42 may be adjustable depending on the viscosity of the density of gypsum slurry 38, the speed of linear travel of the glass fiber mat 14 and the amount of the gypsum slurry 38 to be applied to the mat 14. In effect, the roll coaters 40, 42 serve to deliver the slurry 38 through the small random openings between, fibers of mat 14 and deposit the material on the top of the fabric web in greater or lesser amounts, as desired, filling the openings and coating both the bottom face as well as the top face of mat 14.

Although the roll coaters 40, 42 are shown rotating in the direction of travel of the bottom embedded sheet 14, it is possible, and in some embodiments of this invention, desirable to have the roll coaters rotate in the opposite direction from that shown in FIG. 1. In such case, a mechanism such as a forming belt line, disposed downstream of the roll coaters 40, 42, described below, is utilized to provide a motive force for pulling the bottom embedded sheet 14 through the gypsum board forming station 10, even against the reactive forces produced by counter-rotating coater rolls. Of course, alternatively, other means may be utilized at different locations in the processing production line to provide the motive force for moving the sheet 14 through the station 10, for example, another set of rollers downstream (not shown) that pull the mat 14 toward the right. It should be noted that the gypsum slurry layer on the top surface of bottom embedded sheet need not be absolutely level or completely even since subsequent steps in the process may provide additional smoothing opportunities, as will be described below.

Gypsum composite building panels with mineral fiber embedded sheets may be produced in multiple layers, including, but not limited to, a strong, denser upper and lower surface layers and a less strong and less dense middle layer or core. The layered structure is advantageous as it allows the gypsum board to have a reduced weight, without sacrificing the composite structural strength of the final gypsum board product. Thus, and in accordance with the teachings of aforementioned U.S. Pat. No. 5,908,521, the continuous mixer 30 is configured to provide a second, less dense gypsum slurry, referred to as core gypsum slurry 44 or simply slurry 44, which comprises the bulk of the material in the finished gypsum board products. The core gypsum slurry 44 is pumped out of the mixer 30 by a control device 46 and through an outlet 48, which may comprise a rubber boot or hose. A continuous layer of the unset slurry 44 is caused to form onto the laterally moving combination bottom embedded sheet 14 and layer of dense slurry 38.

The core slurry 44 may comprise a different composition of constituent material than the dense gypsum slurry 38, for example by the addition of filler or strengthening additives, as is known, or may simply comprise the same constituent elements but may have a lighter or less dense consistency because the gypsum slurry 44 contains foaming materials therein, which are not added to the dense slurry 38. It is known that a longer mixing time for the unset gypsum causes more of the entrained air bubbles, sometimes referred to as foaming, to reach the surface of the unset gypsum and thus to be removed from the unset gypsum slurry material. It is the greater amount of air, entrained as miniscule air bubbles, which gives rise to the lighter, less dense core gypsum slurry 44.

Gypsum slurry, and especially gypsum slurry that has been modified with polymer additives, has adhesive characteristics in its wet state that present some difficulty in handling. Accordingly, a film coating 43 is preferably provided on at least one of the roll coaters, preferably roll coater 42, which allows for easier continuous separation of the coater wheel surface from the surface of the wet gypsum surface while simultaneously depositing the majority of the gypsum slurry 38 on the mat of sheet 14. Materials for such a film coating surface include appropriate polymers, such as a coating of tetrafluoroethylene fluorocarbon, fluorinated ethylene propylene, commonly referred to as Teflon®, that are capable of providing a firm surface, yet avoiding gypsum slurry adhering or clinging to the surface of the roll coater wheels.

Another important reason for providing a denser slurry layer, in conjunction with a lighter core slurry layer in the gypsum board, is that the boundary between the dense slurry layers 38, and the core slurry layer 44 provides an inhibiting barrier that serves to control and inhibit the migration of the polymer additives from the surface dense slurry layer 38 to the core slurry layer 44. This migration is most likely to occur during the conventional heat rendering process, described below, used for drying the finished board product. The resulting board product is rendered better equipped to retain the polymer additives in the surface dense slurry layer 38, which thus form a better, more uniform polymer matrix base or “root system” for co-polymer formation with finishing products, as is described below.

As the dense gypsum layer 38 dries and cures, the polymer additives entrained therein migrate toward and through the underlying fiber embedded sheet 14 and the migration may extend into the core slurry layer 44 in the form of tendrils or roots that provide for a greater integrity in the bond formed between the core gypsum layer 44, the fiber sheet 14 and the overlying dense slurry layer 38. Moreover, because the lighter gypsum layer 44 includes an entrained foam, and the dense slurry layer 38 does not, the penetration of the additive materials is deeper into the layer 44. This bonding produced by the impregnated additive polymeric material improves matrix formation, ultimately improving the surface hardness and structural integrity of the finished gypsum board, and provides a strong outer shell to the board and also improves the load bearing capacity, contributing to its flexibility. Optionally, the lighter slurry layer 44 may itself have entrained additive polymers, albeit in much lesser amounts than in the dense slurry layers 14, 114, that can act to bind or cross-link with the polymer additives in the lighter slurry layer 44, and so form a chemical bonding between the gypsum layers as well as a physical bonding in the setting process when the gypsum form one layer intermixes with the gypsum slurry form another layer and so forms a unitary gypsum board product that is much harder to delaminate.

Referring again to FIG. 1, after passing through the roll coaters 40, 42, the bottom embedded sheet 14 passes onto a second forming table 50 having a horizontal forming surface 52. Although the first forming table 16 and second forming table 50 are shown as separate tables in the diagrammatic rendition of FIG. 1, it is possible and in certain cases preferable, that the forming table comprises one elongated table (not shown) with several cutout portions within which, for example, the creaser wheel assembly 20, or the roll coaters 40, 42 and vibrators, are mounted.

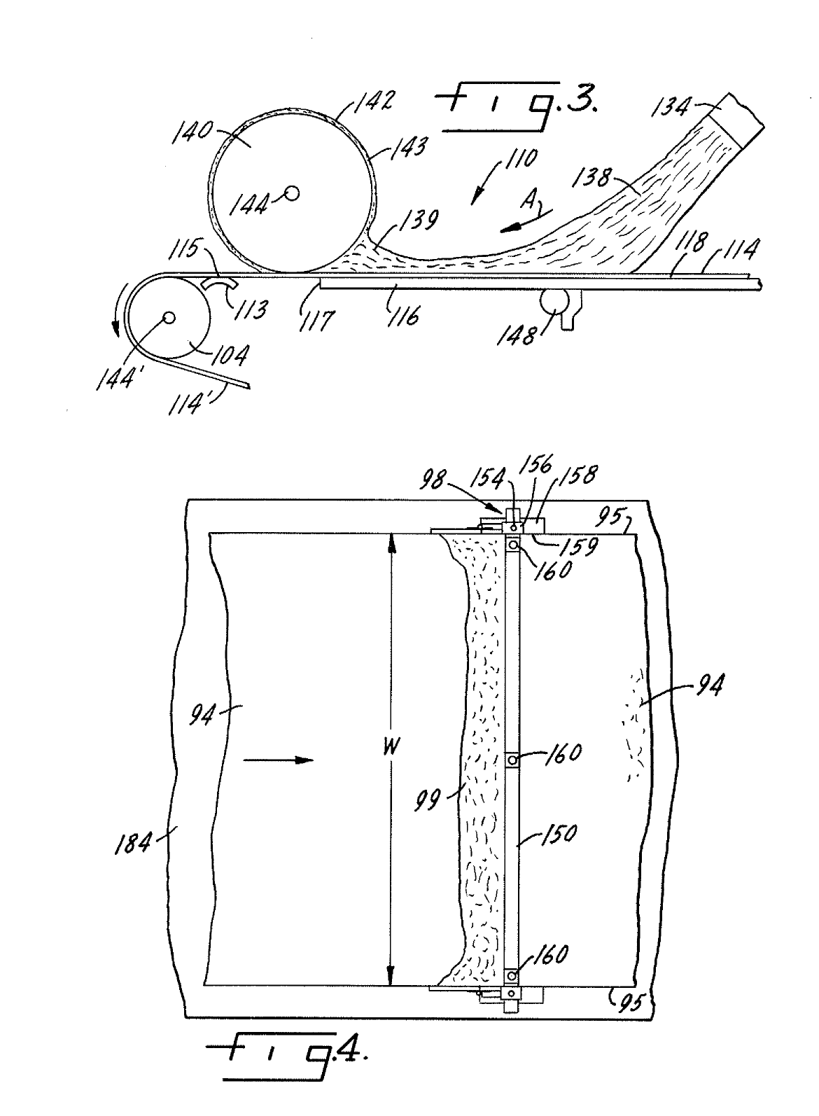

To facilitate the transport of the bottom-embedded sheet 14, including the weight of the dense slurry 38 and core slurry 44, a non-stick table deck 59 is disposed over the surface 52 of table 50. Referring now to FIG. 2, which is a detailed view of FIG. 1, an upwardly facing surface 60 of table deck 59 provides a working surface for the production of gypsum board. Preferably, the table cover comprises a smooth, non-stick material, such as stainless steel, an elastomeric material, e.g., rubber, or a polymeric material, e.g., Formica®, a heat-resistant, wipe-clean, plastic laminate of paper or fabric with melamine resin available form Formica Corporation of Cincinnati, Ohio, and is of sufficient structural strength to support the moving weight of the slurry 44 deposited on the table 50.

As is evident in the detailed cross-sectional view of FIG. 2, the table deck 59 rests directly on surface 52 of table 50, so that as the core slurry 44 is deposited on the bottom embedded sheet 14, the weight of the slurry 44 places downward pressure on the sheet 14, resulting in flattening of the under surface of the sheet 14 against the surface of the table deck 59. However, because of the smooth, non-stick characteristics of the table deck 59, the bottom embedded sheet 14 and slurry 38, 44, freely traverse over the forming tables, as described below.

The cross-sectional view of FIG. 1 also does not show the width of the outlet spouts 34 and 48. Various known configurations may be utilized, including an elongated spout that is disposed transversely to the direction of board travel. Such spouts may output a sheet of gypsum slurry across the width of the mat 14. Alternatively, a tubular spout attached to a rubber boot (as shown) deposits a continuous stream of gypsum slurry onto the glass fiber sheet 14. That gypsum slurry stream may then be spread out, before reaching the roll coaters 40, 42, to provide a smooth surface over the sheet 14 by, for example, diagonally angled vanes (not shown) or by specially constructed rollers or a dam that spread the gypsum slurry from the center toward the edges of bottom sheet 14. The exact shape of the spouts is not considered to be critical to this invention, as long as the function is achieved of evenly spreading the gypsum slurry over the entire width of the mat of both the bottom and top sheets.

The unset, less dense core gypsum slurry 44 is deposited on the penetrated bottom embedded sheet 14 at or adjacent a third forming table 56, having a top surface 58, for supporting the combination of penetrated mat 14 and slurry 44. An opening 62 between the second forming table 50 and third forming table 56 provides a space for disposing a first deck vibrator 64, and another opening 66 provides for mounting a second deck vibrator 68 between the third forming table 56 and a fourth forming table 70, having a top surface 72. Such vibrators are described in U.S. Pat. No. 4,477,300, which is incorporated by reference herein.

As shown more clearly in the detailed view of FIG. 2, the table deck 59 extends between the first and second forming tables 50, 56 over the opening 62, and also between the third and fourth forming tables 56, 70 over the opening 66. Because each of the tables 50, 58, 70 are disposed so that their surfaces 52, 58, 72 are coplanar, the table deck 59 mounted onto the table is vertically fully supported across essentially the full length of the gypsum board forming station 10, i.e., across the full length defined by second to fourth forming tables 50, 56, 70.

As shown in FIG. 2, deck vibrators 64, 68 each comprise rolls 74, which are mounted immediately adjacent sections of the table deck 59 covering the upper portion of the respective openings 62, 66. Each of the deck vibrator rolls 74 are mounted to rotate around axles 76, both extending horizontally in a direction transversely to the direction of travel of the board production line. Each of the rolls 74 has a diameter that is just slightly less than the radial distance between each axis 76 and the bottom surface 62′, 66′ of the table deck 59 covering the respective openings 62, 66.

Each deck vibrator 64,68 further comprises a plurality of bumps 78 which extend radially beyond the outer surface 79 of the deck vibrator rolls 74. Bumps 78 extend longitudinally along the surface 79 of the rolls 74 in a direction parallel to the axis 76. As the deck vibrator rolls 74 rotate about axis 76, the bumps 78 routinely strike the underside surfaces 62′, 66′ of the table deck 59, which momentarily lifts the table deck 59, together therewith the bottom embedded sheet 14 and slurry 38, 44, combination, which agitates the slurry resting on sheet 14. Such agitation causes the slurry 38 to even out over the upper surface of the penetrated mat 14 and also causes the slurry 44 to more completely permeate through and bond with the denser slurry 38 located on the upper surface of the bottom embedded sheet 14.

Another feature provided by the deck vibrators 64, 68, is the “kneading out” of larger entrapped foam air bubbles from the bottom surface of the bottom embedded sheet 14. As the bottom-embedded sheet 14 passes over the openings 62, 66, the denser slurry 38, which has penetrated through the mat of bottom embedded sheet 14, is still unset and continues to have entrained air bubbles within the gypsum slurry and adjacent bottom sheet surface. Vibration from the deck vibrators 64, 68, causes these foam bubbles to reach the surface and exit from within the penetrated gypsum slurry 38, thus resulting in a smooth outer surface of the completed gypsum board when the manufacturing process is completed, as in aforementioned U.S. Pat. No. 4,477,300.

Completion of the smoothing operation of the slurry 44, resulting in an essentially planar combined bottom embedded sheet 14 and core slurry 44 is further facilitated by a forming plate in the top and bottom sheet joining station 80 (FIG. 1), disposed downstream, i.e., toward the right as seen in FIG. 1, of the deck vibrators 64, 68. The forming plate assembly of sheet joining station 80 operates in conjunction with a top embedded sheet 114 formed by the sheet coating station sub-assembly 110 having similar elements to those in the main production line that form the bottom-embedded sheet 14.

Top-embedded sheet 114 is comprised of a sheet or mat of randomly aligned mineral fibers, such as glass fibers, and is unrolled from a supply roll 112, similar to the supply roll 12. Similar elements to those used for the production of bottom embedded sheet 14 are identified by like numerals in the 100 series, utilizing the same two last digits as those identifying the like elements in the production of the bottom sheet 14. Supply roll 112 pays out a continuous top embedded sheet 114, which, in the completed gypsum board, will be adjacent the inner facing surface of the gypsum board product subsequently used in wall construction.

As shown in FIG. 1, the top embedded sheet 114 may require feeding through various loops around, for example, rollers 102, so as to avoid interference of the main production line by the operation of top sheet sub-assembly 110. Top sheet sub-assembly 110 directs the top embedded sheet 114 over a top sheet forming table 116 having an upwardly facing surface 118.

The continuous mixer 30 further comprises a slurry outlet 134 being controllable by a control device 136 providing a continuous stream of denser gypsum slurry 138 to the sub-assembly 110 for deposit onto the top embedded sheet 114, as shown. A detailed cross-sectional view of the top sheet production station portion of sub-assembly 110 is illustrated in FIG. 3, and reference is now jointly made to FIGS. 1 and 3. Although in FIG. 1, the preferred embodiment of two separate slurry controllers 36, 136 are shown for supplying two different slurry mixtures 38, 138, for, respectively, the bottom embedded sheet 14 and the top sheet 114, it may be desirable to have one mixer discharge leading to dual controllers for controlling the discharge of two or more outlets, similar to that described in aforementioned U.S. Pat. No. 5,714,032. Alternatively, a single controller (not shown) may be used with the discharge outlets having individual valves enabling variable flow of gypsum slurry that is controllable for each outlet spout depending on the operational needs of the board production process.

Shown in FIG. 1, are separate controllers 36, 46, 136, each for controlling the output of a single outlet, i.e., dense gypsum slurry outlets 34, 134, or core slurry outlet 48. The configuration of the continuous mixer 30 provides separate mixing chambers, each attached to, and feeding gypsum slurry to, a separate outlet, which provides a specific type of gypsum slurry, as needed. Customization of the slurry provided to each of the outlets 34, 48, 134 thus enable a gypsum board line operator to provide different slurries, having desirable characteristics, to the location in the manufacturing line where needed. For example, an outlet, such as outlet 34, may be required to provide a denser gypsum slurry, such as slurry 38. The slurry may be desired to include specified additives, for example, a polymeric compound, which forms a matrix with the set gypsum after it sets, so as to provide a suitable surface for further finishing, as will be described below in greater detail. However, if it is only necessary for the front facing surface to have such a surface, then using the embodiment shown in FIG. 1 provides the option to include the additive in only the dense gypsum slurry 38, pumped from controller 36, but not to include such an additive in the slurry 138, which will end up on the inner, back side of the gypsum board during construction. Preferably, the gypsum slurry 138 is denser than the core slurry 44, and may have an identical consistency as that of the slurry 38 coating the bottom embedded sheet 14. The additive may be mixed into one or more of the desired slurries by providing a turbulator device, in accordance with the teachings of aforementioned commonly-owned U.S. application Ser. No. 10/968,680 either at the controllers 36, 46, 136, or in line protruding into the slurry outlet 34, 48 or 134 so that the additive can be added to the slurry stream during the transport from the mixer to the point of deposition of the slurry onto the mats 14, 114.

Referring again to FIGS. 1 and 3 showing the top sheet slurry coating station 110, the dense gypsum 138 is deposited on the top embedded sheet 114, comprised of a mat of glass fibers, which is moving in the direction shown by arrow A, past the surface of the top sheet slurry table 116. The top sheet is moving essentially at the same rate as that of the bottom embedded sheet 14 traveling over forming table 16. The gypsum slurry 138 is denser than the core slurry 44, and may have an identical consistency as that of the slurry 38 coating the bottom-embedded sheet 14.

The top facing sheet slurry coating station 110 comprises a short forming plate 116, similar to the forming table 16, with the exception that the linear dimension of plate 116 is much shorter, having a sufficient length to achieve deposition of the gypsum slurry 138 and to spread out the slurry over the surface of the moving top embedded sheet 114 between the lateral edges of the continuous sheet 114. To assist in the process of spreading the gypsum slurry 138 over the surface of sheet 114, one or more pneumatic table vibrators, such as vibrator 148, may be included to vibrate the surface 118 of the table 116.

The mechanism for coating the top embedded sheet 114 is modified somewhat from that of the bottom embedded sheet 14 because the linear dimension taken up by the top sheet roll coater station 110 is reduced to a minimum. The linear dimension of the station 110 is reduced so as to accommodate disposition in the space directly above the main forming and working tables 16, 50, 56, 70. Such accommodation is seen, for example, in including two roll coaters horizontally displaced from each other so that the top embedded sheet 114 is coated by roll coater applicator wheel 140, and then pulled toward transition roll 104.

Applicator wheel 140, having a cylindrical surface 142, rotates about an axle 144, which axle 144 extends transversely to the direction of travel of the sheet 114. The vertical and horizontal disposition of axle 144 is important in obtaining the desired result of sheet 114 being fully impregnated with the dense slurry 138. As shown in FIG. 3, axle 144 is disposed linearly at a very short distance past the edge 117 of table 116. The axle is vertically disposed just slightly less than the radius of wheel 140 above the table surface 118 so that the applicator wheel 140 extends into the space under the plane defined by the table surface 118. As is shown in FIG. 3, during production the applicator wheel 140 puts downward pressure on top embedded sheet 114, which sheet is deflected some slight distance from its linear path followed across the table surface 118.

The dense gypsum slurry 138 being deposited on the mat 114, to form moving top embedded sheet 114′, produces a slurry concentration at a dam 139, comprised of excess dense slurry 138, which collects in the constricted space between the applicator wheel 140 and the top embedded sheet 114′. The size of dam 139 can vary, depending on the desired characteristics of the resulting impregnated top embedded sheet 114′ that is produced at the top sheet coating station 110. For example, if a greater degree of coating is desired to provide greater structural strength of the gypsum board, then the size of the dam 139 may be adjusted so that a greater amount of dense gypsum slurry is impregnated into the interstices between the mineral fibers of the mat comprising top embedded sheet 114′. For purposes of distinction, top sheet 114 is designated as impregnated top embedded sheet 114′ after impregnation by the dense slurry 138.

The size of the dam may be adjusted by varying any of a number of different parameters of the materials and devices of the top sheet coating station 110. Among the variable parameters that can be adjusted that will affect both the size of the dam 139 and the degree of coating produced by the applicator wheel 140 are the linear speed of the moving top embedded sheet 114, the amount of dense gypsum slurry 138 deposited, the direction and speed of rotation of the applicator wheel 140, and the vertical and horizontal dispositions of the axle 144 relative to the table surface 118 and the edge 117, respectively. These adjustments may be utilized to produce the desired amount of dense slurry impregnated into the top embedded sheet 114, the amount of dense slurry 138 that penetrates through sheet 114 to coat the “bottom” surface of sheet 114, i.e., the surface closest to the table surface 118, and the weight of and rigidity resulting from the final impregnated top embedded sheet 114′ produced at the top sheet coating station 110.

Working in conjunction with the applicator wheel 140 is downwardly curved transversely extending directional plate 113, upon which the sheet 114 impinges as it exits from contact with the applicator wheel 140. The directional plate 113 is preferably mounted so that the apex 115 is adjacent or within the plane defined by the surface 118. This positioning causes the sheet 114 to be placed into tension as the applicator wheel 140 pushes the sheet 114 downwardly from the plane, which disposition assists in the penetration of the gypsum slurry 138 through the mat of sheet 114. To inhibit the formation of slurry 138 on the surface 142 of applicator wheel 140, an appropriate thin film coating 143, comprising, polyethylene, or, for example, a tetrafluoroethylene fluorocarbon and fluorinated ethylene propylene (Teflon®) coating, may be optionally disposed on the surface of wheel 140, similar to the coating 43 of roll coater 42 described above.

The top sheet 114′, now impregnated with the dense gypsum slurry 138, is directed from the applicator wheel 140 to a second roller wheel, the transition roller wheel 104, having an axle 144′ that is parallel to axle 144. The transition roller wheel 104 is in the general path and in the plane defined by the surface 118, and its function is to change the direction of travel of the top embedded sheet 114′ so as to invert the top surface of the sheet to become the bottom surface, and vice versa. That is, the surface of the top embedded sheet 114 that was on the bottom, adjacent the surface 118, becomes the top surface and the sheet 114′ is ready for delivery to and joining over the core slurry 44, as is described below.

Sheet joining station 80 comprises a circular pin 82 for receiving the impregnated top embedded sheet 114,′ and a forming plate comprised of a first forming plate section 84, and a second forming plate section 86, joined to each other at an appropriate juncture 88, as shown. The forming plate is mounted directly above the primary board production line, and provides the function of joining the top embedded sheet 114′ to the core slurry 44 disposed on the bottom embedded sheet 14.

Circular pin 82 extends laterally across the width of the top embedded sheet 114′, which is directed from the transition roller wheel 104 so as to come into contact with the pin 82. Pin 82 is attached, either integrally or by an appropriate attachment mechanism, to the first forming plate section 84 so that there is a seamless transition experienced by the top embedded sheet 114′ as it comes down from the top sheet coating station 110. Forming plate section 84 is disposed at an angle to the primary board production line and to the surface 72 of the forming table 70. The angle between forming plate section 84 and the surface 72 may be adjustable, may be provided with preset angular value so as to provide a constriction for retaining a slurry head 44′ during the production process, as shown. This angular constriction operates in a similar way as that of the constriction between the applicator wheel 140 and the forming plate 116 to collect an excess of core slurry 44 and thus produce a slurry head 44′ at the sheet joining station.

The slurry head 44′ provides the function of collecting core slurry 44 at the head 44′ that provides a continuous supply of slurry to fill in the gap between the top sheet 114′ and bottom sheet 14, and assists in avoiding air gaps or voids in the final gypsum board between the two embedded surfaces. Once the faces are joined by the intervening core slurry 44, the top face sheet 114′ has become inverted by transition roller wheel 104 so that its bottom surface, that which was immediately adjacent the surface 118 of forming table 116, has become the top surface 94 of the processed gypsum board, as shown.

The slurry head 44′, because of the angular constriction between the forming plates, continually forces the slurry 44 to be injected into the constricted space adjacent the hinge 88, and so to create an additional pressure on the dense slurries 38, 138, impregnated into the top and bottom face sheets 14, 114′, respectively, the pressure of the slurry head causes the core slurry 44′ to more readily bond with both the dense slurries 38, 138 and also causes the dense slurries 38, 138 to further penetrate through the mats of the bottom and top face sheets 14, 114′, thereby more thoroughly coating the outer surfaces of the finished gypsum board 94, 96.

To facilitate the constriction of the slurry head 44′, the second forming plate section 86, extending from the hinge 88 toward the surface 72 of forming table 70, produces a very acute angle and one section 86 is almost parallel to the surface 72 of the table 70. The acute angle and the smooth surface of the plate sections 84, 86 produces an even smooth surface defining the top surface 94 of the gypsum board, with the overwhelming majority of the mineral fibers of the mat of top embedded sheet 114′ covered by the dense slurry 138, and similarly the face surface 96 also essentially covered by the dense gypsum slurry 38.

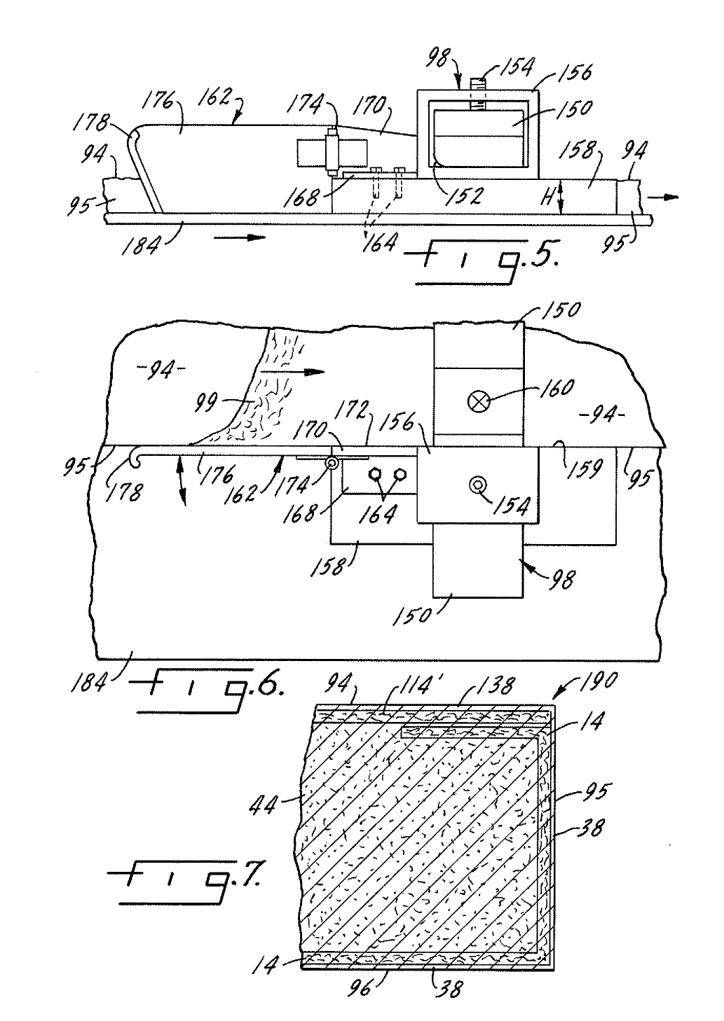

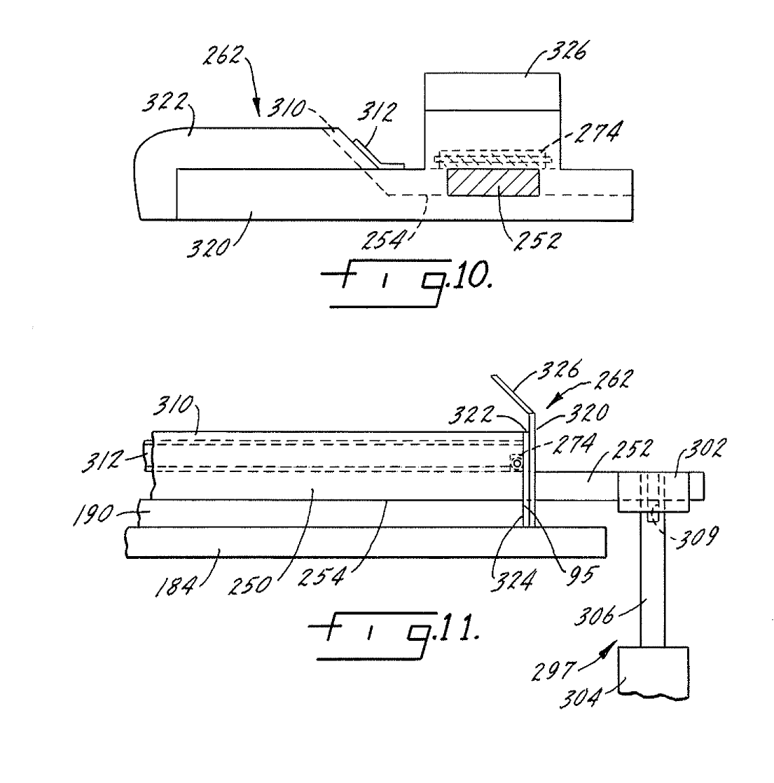

The final forming step in the board production is the edge formation of the two lateral edges of the board. The width of the bottom face sheet 14 upon which the core slurry has been evenly spread out is slightly larger, by about 2.5-5.0 cm. (one to two inches), than the width of the top face sheet 114. As the bottom face sheet 14 passes through the creaser wheel assembly 20, the creaser wheels 22, 22′ crease the edges so that the width between the creases is the predetermined, desired width W (FIG. 4) of the final gypsum boards. The extra width of mat 14 extending beyond the creases for a distance about 2.5 cm (one inch) at either edge, is preferably turned up, and thus provides a border for containing the core slurry 44 which is extruded onto the top face sheet 14 between the creases. As the top face sheet 14 passes through the face sheet joining station 80, and at the lap point in the production line where the two face sheets 14, 114′ are at or close to the desired separation essentially defining the thickness of the gypsum board, a mechanism at the sheet joining station (not shown) completes the inward folding of the creased portions and simultaneously deposits embedded sheet 114′ over the folded edges to produce a formed board edge 95 (FIG. 7).

The creased edges of the bottom embedded sheet 14 are thus turned over and the top embedded sheet 114′ is set into the inward folds of the bottom embedded sheet 14, thus completing the covering of the longitudinal edges of the gypsum board, sometimes referred to as the machine edges. Completely penetrated dense gypsum slurry at the lap point of sheets 14, 114′ thus sets up and seals the edges 95 of the gypsum board product 190 (FIG. 7).

The gypsum board at this stage of production passes from the gypsum board forming station 10 toward the remainder of the finishing process that takes place on the belt line 180. To facilitate the passage of the gypsum board from the forming station 10 to the belt line 180, the forming table 70 includes a forming table extension plate 78 supported by the forming table 70, and extending from the edge of table 70 toward the surface of the belt line 180. It is important for maintaining the final smoothness of the gypsum board surface 96 that the amount of vertically unsupported gypsum board is minimized when the gypsum is still in a wet state, effectively remaining as a slurry before setting. At the distal end of the board forming station 10, forming table 70 is adjacent the belt line 180 and the board passes from table 70 to belt line 180. Belt line 180 comprises at least one set of roller wheels, one roller wheel 182 which is shown in FIG. 1, with an endless belt 184 looped about the roller wheels 182, which provide a means for motive power to transfer the sheets 114 and 114′ and for removing the still wet gypsum board away from the board forming station 10.

The production of the gypsum board at the board forming station 10 is capable, as a result of the modifications described above to efficiently produce gypsum board at the rate of about 45 meters (150 feet) per minute or even higher rates. Accordingly, the rate of the moving belt 184 must match the speed of production, and the two rates are ideally coordinated so that increasing the production speed also increases the speed of the belt 184. As shown in FIG. 1, the edge of the forming table extension plate 78 is as close as possible to the beginning of the belt 184 so that the gypsum board passes from the forming table 70 to the belt line 180 sub-assembly without interference, all the time having vertical support of the gypsum board from the extension plate 78 and belt 184. To facilitate the transfer, the table deck 59 has a top-working surface that is essentially coplanar to the surface of belt 184.

To further improve the appearance and smoothness of the gypsum board back face 94, a first edger bar assembly 98 is disposed adjacent the gypsum board back face 94 and above the belt 184, at a point disposed further along the length of the board production line, as shown in FIG. 1. FIGS. 4, 5 and 6 illustrate in greater detail the first edger bar assembly 98, which provides an optional additional manufacturing operation for providing surface smoothing of the dense slurry layer 138.

The edger bar assembly 98 (FIGS. 4, 5 and 6) rides above the belt line 184 immediately adjacent the face 94. The edger bar assembly 98 is mounted in place to stabilize its horizontal position by an appropriate mounting mechanism such as a stabilizer mount. The assembly 98 comprises an edger bar 150 having a rounded front bottom edge 152, which is the leading edge that comes into contact with the gypsum board 94 passing below the edger bar 150. Edger bar 150 continually contacts the wet gypsum slurry face 94 to provide a trowel effect over the gypsum board surface so as to skim over any remaining uncovered areas to fill them in. The edger bar 150 may also create a small slurry dam 99, across the field of back face 94, as shown in FIG. 4, the size of which may be adjustable by adjusting the vertical separation between the bottom edge of the edger bar 150 and the surface of belt 184.

The vertical position of edger bar 150 is adjustable by means of mounting screws 154 which themselves are attached to two laterally disposed tubular clamping elements 156 for retaining the edger bar 150. As shown in FIG. 4, the length of edger bar 150 is longer than the width of the gypsum board surface 94, and the inboard edges of the clamping elements 156 are separated by a lateral dimension equal to the width W of the board. Optional pneumatic vibrators 160 are mounted within the edger bar 150 to assist in the gypsum slurry smoothing operation and to inhibit slurry buildup on the edger bar 150.

As described above, gypsum board and belt 184 are continually transported by the belt line 180 in the direction of the arrow, as shown. The edger bar clamping elements 156 are themselves mounted upon two laterally disposed edger shoes 158 that ride directly upon the upper most surface of the belt 184. The height of the edger shoes 158 above the belt 184 approximates the thickness of the gypsum board. The longitudinal edge 95 of the gypsum board is in continual contact with the board surfaces 159 of the edger shoes 158, the contact completing the forming of the surface at the longitudinal edge 95. As shown in FIG. 4, the edger bar 150 maintains a slurry head 99 that spreads out over the board surface 94, and which completes the forming of a smooth surface 94 in which exposure of glass fibers is minimized by the gypsum slurry coating.

An edge flapper mechanism 162 is also mounted onto the top of each edger shoe 158 by an appropriate attachment means, such as bolts 164. Bolts 164 attach one leg 168 of a stationary L-shaped mounting bracket (not shown in FIG. 1) to the top surface of the edger shoe 158, as shown. The other leg 170 of a mounting bracket may extend vertically from the horizontally extending leg 168 such that an inward facing surface 172 is coplanar with the inwardly facing surface 159 of edger shoe 158. The vertical extension of leg 170 is high enough above the board surface 94, so that the slurry head 99 forming thereon does not spill over the top of the edge flapper mechanism 162.

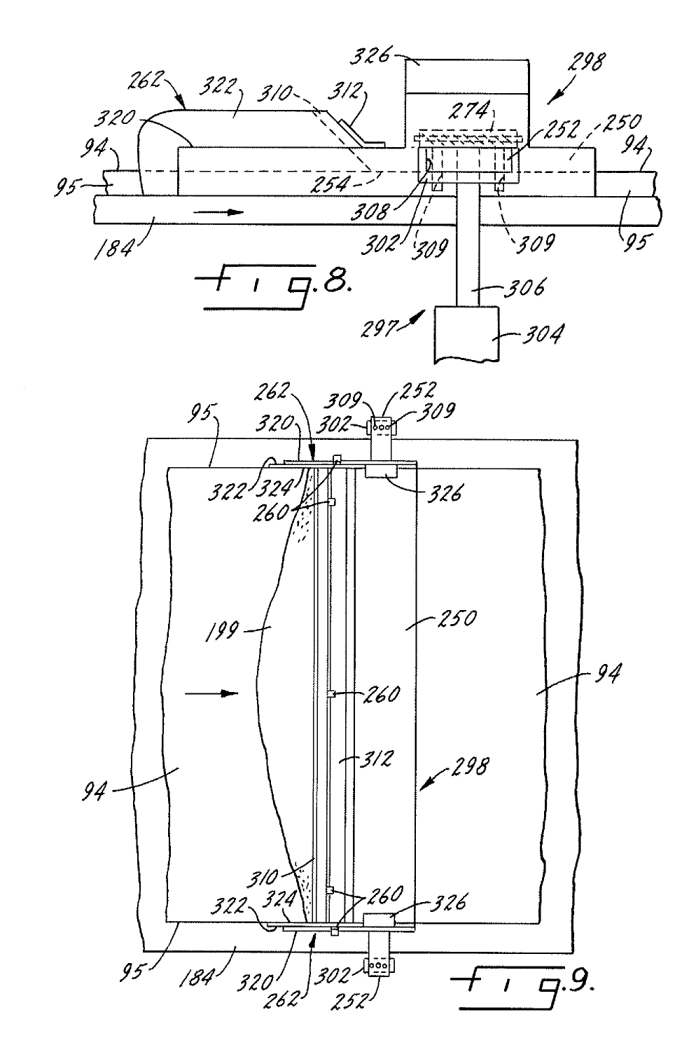

The vertically extending leg 170 includes a vertical spring hinge 174, that attaches an edge flapper 176 to the vertically extending leg 170, such that the edge flapper 176 is capable of rotating to a limited extent about the hinge 174, as shown by the double arrows in FIG. 5. The spring hinge 174 forces the edge flapper 176 to abut the longitudinal edge 95 of the gypsum board, the force of the spring hinge 174 being sufficient to retain contact between the edge flapper 176 and the board longitudinal edge 95 to counter the horizontally directed pressure of the slurry head 99. The edge flapper 176 has a rounded leading corner 178, which assists in the gathering of any slurry overflow so as to retain the gypsum slurry on the board surface 94.

During board manufacture, the edger bar 150 is displaced horizontally a very short distance from the rotating wheel 182 so as to absorb the sudden impact of any excess upwardly directed pressure on the edger bar 150, such as may arise from an anomaly in the board or during start up or shut down procedures. The belt line 180 provides some flexibility so that a sudden, slight upward or vertical pressure may be accommodated without disturbing the surface coating 94 of the gypsum board.

The edger bar 150 also produces an improved, smoother and denser gypsum layer on surface 94 than that which is produced by the first penetrated slurry coat 138 applied by the top roll coater sub-assembly 110. This denser coat arises from the tendency of the second slurry head 99 to continue the process of extruding entrained air bubbles from the wet slurry mixture.

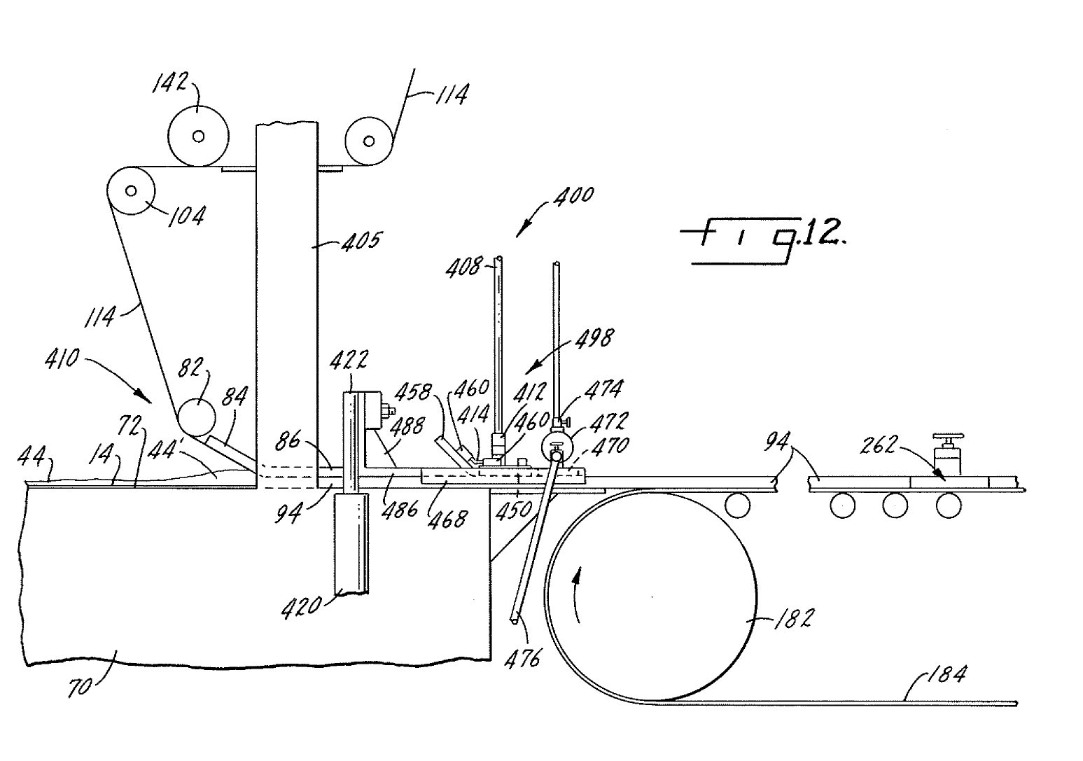

A second, and preferred, embodiment of the edger bar assembly 298 is illustrated in FIGS. 8-11. In many respects, the edger bar assembly 298 is similar to edger bar assembly 98. Assembly 298 also rides above the belt line 184 immediately adjacent the board face 94. The edger bar assembly 298 is mounted in place to stabilize its horizontal position by an appropriate mounting mechanism, such as stabilizer mounting device 297, as shown. The mounting device 297 comprises a mounting base 302, firmly attached to a stable position, for example the ground or the underlying structure of the conveyor system 180. The stabilizer mounting device 297 may further include a lift piston 306 within the mounting base 304 for driving the mounting arm 302 in a vertical direction. Mounting arm 302 engages the edger bar mounting extensions 252 and can be electronically or otherwise controlled to change the vertical position of the edger bar, as will be explained below.

Similar to edger bar assembly 98, edger bar assembly 298 also includes an edger bar seat 306, upon which the remaining elements of edger bar assembly ride. Bar seat 306 includes an aperture 308, and two or more vertical secondary apertures 309 for providing orientation and stabilization for the edger bar.

Edger bar assembly 298 includes a modified edger bar 250 having edger bar mounting extensions 252 extending laterally from the edger bar 250 and in to the apertures 308, one at either lateral edge of the assembly 298. As is best seen in FIG. 9, the edger bar extensions 252 extend beyond the lateral edge of the conveyor belt 184, where they engage the stabilizer portions of the edger bar assembly 298. The vertical position of the edger bar assembly 298, and of the edger bar 250, and the separation between the edger bar 250 and the top surface of the conveyor belt 184 is controlled to maintain a desirable thickness of the gypsum plaster board 190.

The bottom skimming surface 254 of edger bar 250 continually contacts the wet gypsum slurry face 94 to provide a trowel effect over the gypsum board surface so as to skim over any remaining uncovered areas and thereby fill them in. The edger bar 250 may also create a small slurry dam 199 across the field of back face 94, as shown in FIG. 9, the size of which, by means of the stabilizer mounting device 297, may be adjustable by adjusting the vertical separation between the bottom surface of the edger bar 250 and the surface of belt 184.

To assist in maintaining a slurry dam 199 capable of providing a skimming effect to produce a smooth board surface 94, a forward angle, pre-forming plate 310 defines as a leading edge of the edger bar 250. The forward angle, pre-forming plate 310 provides the function of blocking and directing excess gypsum slurry to the head 199, thereby creating a ready source of the gypsum slurry, as shown in FIG. 9, which head 199 provides the gypsum slurry for filling any remaining voids on the surface, and for smoothing out the surface 94 of GRG board.

Forward angle, pre-forming plate 310 defines an acute angle relative to the surface 94 which is capable of gathering the gypsum slurry that is skimmed off the gypsum board surface 94 and redirecting it to be reformed on to the desirable smooth surface. A preferred value for this angle is between about 30°-60°, with a most preferred value being about 45°. The forward angle, pre-forming plate 310 may have a backing plate 312, also having two sections defining a similar acute angle. Backing plate 312 provides a supporting structure for the forward angle, preforming plate 310.

The pre-forming forward angle plate 310 of the edger bar 250 is preferably integrally formed with the edger bar itself, or alternatively, may be attached thereon by appropriate means (not shown). It is important, however, that the transition from the bottom surface of the pre-forming forward angle plate 310 to the forming surface 254 of the edger bar 250 should be smooth and without impediments to the even coating of the gypsum slurry over the surface 94. Although shown in phantom in FIG. 8 as a sharp angled juncture, a round smoother transition between the pre-forming plate 310 and surface 254 may be preferable. The longitudinal width of the edger bar 250 has a length in contact with surface 94 that is longer, in the direction of travel of the gypsum board having a length of about 20 cm (8 inches). This longer length results in a longer smoothing contact of the edger bar 250 with the surface 94.

To provide a smoother, non-stick surface 254, it may further comprise a Teflon® coating on the underside of the second forming plate defined by the under surface of edger bar 250. Alternatively, the entire edger bar 250 may comprise a non-stick material such as Teflon®.

To provide increased capability of smoothing and completion of the desired geometrical configuration during formation of the gypsum board lateral edges 95, an edge flapper subassembly 262 is amounted to operate together with edger bar 250, as is described below.

Optional pneumatic vibrators 260 are preferably mounted within the edger bar assembly 298, preferably on the pre-forming forward angle plate 310, to assist in the gypsum slurry smoothing operation and on the flapper edger sub assembly 262 to inhibit slurry buildup on the edger bar 250.

As described above, gypsum board and belt 184 are continually transported by the belt line 180 in the direction of the arrow, as shown in FIG. 9. However, a significant difference in this embodiment (FIGS. 8-11) is that the edger bar assembly 298 does not ride on the surface of the belt 184, but has a height relative to that surface that is independently controlled by the mounting device 297, as described above. As shown in FIG. 9, the edger bar 250 maintains a slurry head 199 that spreads out over the board surface 94, and which completes the forming of a smooth surface 94 in which exposure of individual glass fibers is minimized by the gypsum slurry layer.

Edger bar assembly 298 further includes an edger flapper mechanism that is mounted onto the edger bar 250 by an appropriate attachment means, may engage both the edger bar extensions 252 and through appropriate apertures 308, which may be threaded, in the mounting arm 302. The attachment of the edger bar assembly 298 to the mounting stabilizer device 297 through mounting base 302 provides for a unitary edging mechanism that creates a smooth surface 94 and simultaneously provides a smooth gypsum layer on the edges 95 of the gypsum board.

Another difference with the edger bar assembly 98 is the omission of edge shoes. Instead, the edger bar assembly 298 includes disposing the Teflon® flaps 320 at opposite ends of the edger bar 250, comprising a dimension in the range of from about 15 cm (6 inches) to about 180 cm (72 inches). The Teflon® flaps 320 are disposed abutting the edge 95 of the gypsum board so as to form it in a squared or other geometrical figured edge. A Teflon®material is preferred to provide a smooth surface that will not interfere with the continuous passage of the gypsum board in the direction of the arrow as shown in FIG. 9.

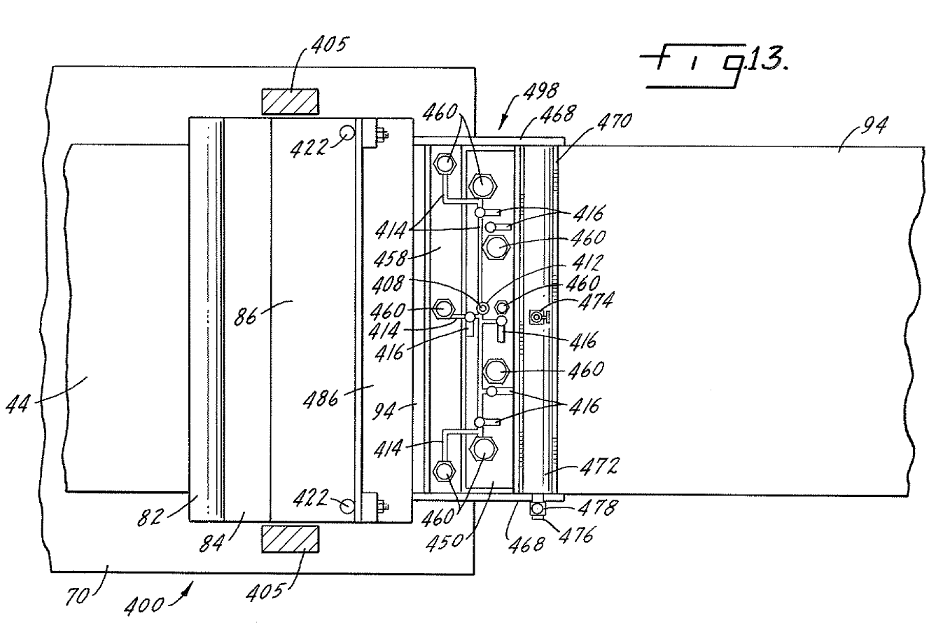

To further inhibit the excess formation of gypsum slurry on the surface of board edge 95, an edge flapper mechanism 262 is disposed to work in conjunction with the Teflon® flaps and the edger bar 250. The edge flapper mechanism 262 (FIGS. 10 and 11) also provides a means for retaining the slurry head 199 from over flowing over the gypsum board edges 95 during production, and inhibits formation of gypsum slurry patches on the moving belt 184.

The edge flapper mechanism 262 is disposed on the edger bar 250, and attached thereto by an appropriate means for example, as described above relative to the edger bar assembly 98 (FIGS. 4-6). Referring now to FIGS. 10 and 11, one flapper 322 is disposed over the flaps 320, and can pivot relative thereto as a result of a pivotal spring hinge 274, which attaches the flapper 322 to the edger bar 250. As in the edge flapper 162, the spring hinge 274 provides a tensional force to abut the edge flapper 322 against surface 95 rotationally about the spring hinge 274, the spring hinge 274 providing sufficient force to retain contact between an inner surface 324 of the edge flapper 322 and the gypsum board longitudinal edge 95. The force of spring hinge 274 counters the horizontally directed pressure of the slurry head 199. The edge flapper 322 may include a compression activated lifting lever 326, which assists in forcing the flappers 322 to rotate upwardly when the assembly 298 is raised away from surface 94. The specific arrangement of the edger bar assembly 298 disposes the edge flapper mechanism 262 directly against the longitudinal edge 95 of the gypsum board. However, the configuration differs from that of edger bar assembly 98 in that the edger bar extension 252 extends away from the edge flapper mechanism 262 so as to remove and somewhat isolate the extension and elevational controls 297 from the edge flapper mechanism 262. This configuration does not impact greatly on the operational efficiency of the edge flapper 322 or the edger bar 250, which provides similar functions to that of the edger bar assembly 98 in a similar way, but the configuration tends to maintain the pneumatic devices free and clear of gypsum slurry so as to avoid problems with the operations thereof.

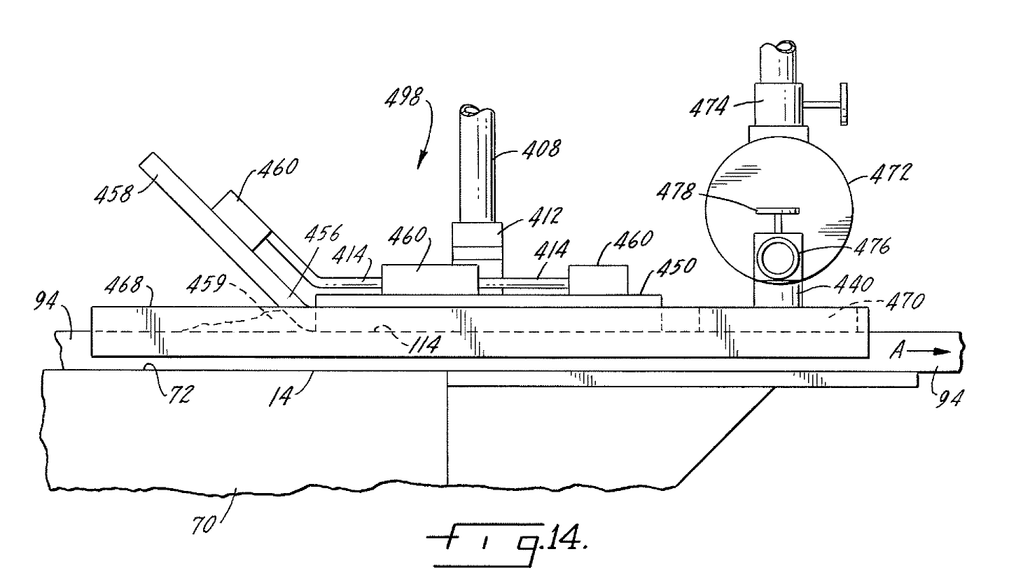

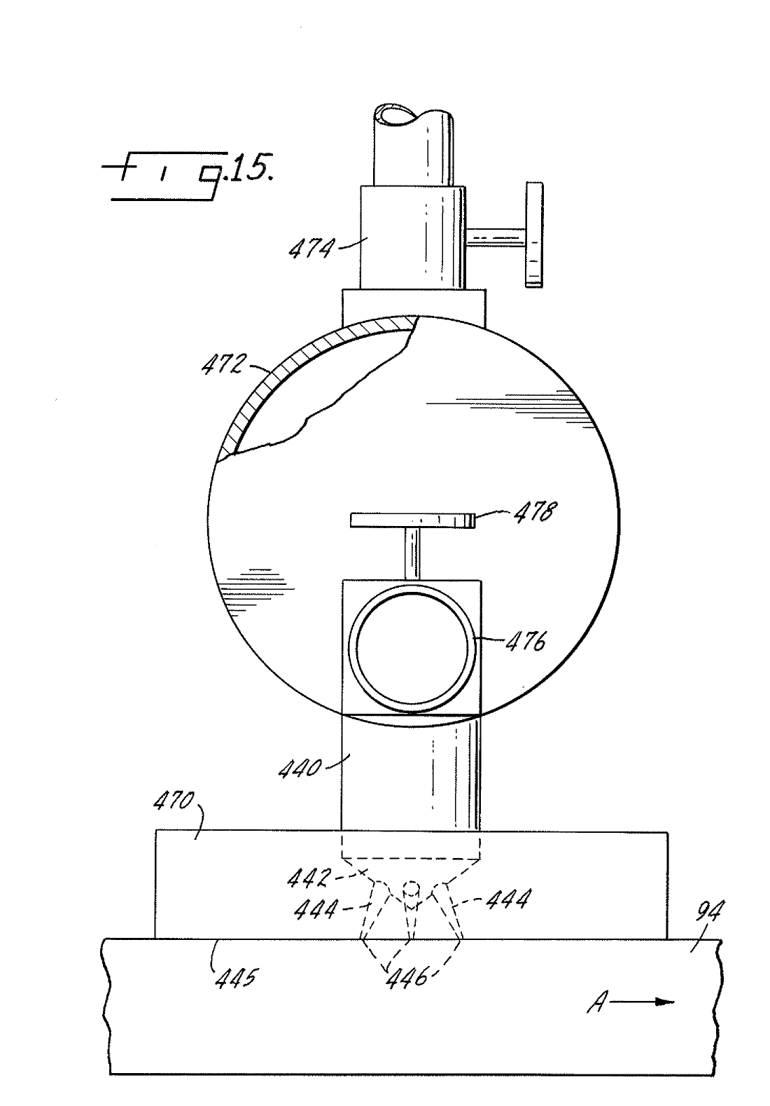

Referring now to FIGS. 12-14, yet another embodiment of the edger bar mechanism is illustrated, shown disposed downstream of the gypsum board manufacturing station. The equipment and process for the manufacture of the gypsum board itself, prior to the final edge finishing steps, is generally identical to that of the previous embodiments, and will not be described in great detail herein. Thus, identical or like elements will be designated with the same reference numerals and different reference numerals will designate those unique portions of this embodiment.

FIG. 12 illustrates a diagrammatic or schematic elevational view and FIG. 13 illustrates a top diagrammatical view of the gypsum board production and transportation line, designated generally as 400. The gypsum board production includes a bottom embedded sheet 14 and a top embedded sheet 114, with the slurry 44 being disposed between the two sheets of randomly aligned inorganic fiber material. The apparatus includes pin 82 and forming plate sections 84, 86, for producing a gypsum board 94 having a desired thickness. A post 405 is shown for mounting the top sheet delivery system 410, including a mount for the mat roll 112 (FIG. 1). The forming table 70 provides the working surface for gypsum board manufacture.

As shown in FIGS. 12 and 13, additional extensions 486 of the forming plate 86 are shown, supported by a forming plate support 488. The forming plates 86, 486 and support 488 comprise a leading edge portion of a back skim coater assembly 498, connected together and being transposable in a vertical direction, and the transposition of assembly 498 being controlled by a forming plate lifting system 420 transpose the assembly vertically along post 405. Lifting system 420 preferably includes an actuator 422, either electromechanical or hydraulic, for adjusting the height of the forming plate support 488, and forming plates 86, 486, from the surface 72 of the forming table 70, to obtain the desired gypsum board thickness. The lifting system 420 may also lift the forming plate assembly 498 to a remote location spaced from the board 94, during times when the production line is down, so as to provide easy access to the equipment for adjustment, repair or cleaning.

It is advantageous and preferable that a film of water is provided over the surface of the gypsum board at the point in the gypsum board formation process known in the gypsum board industry as the initial set or stiffening point. At this point, there is a measure of control that can be provided over the board setting process by introducing formulation additives to increase or decrease the speed of recrystallization of the gypsum from solution or slurry form. The preferable method for providing such a water film is illustrated and described in aforementioned U.S. Pat. No. 6,866,492, which is incorporated by reference herein. Thus, the majority of the apparatus for providing the water film will not be described herein since the subject matter of the present invention is directed to coatings on the surface, as described below.

It is a feature of this invention that the moving water film, in conjunction with the contact pressure exerted from the contact surface of the skim coater assembly acts as a trowel mechanism that levels and smoothes the gypsum board surface resulting in a finished gypsum board 94 that has a well finished, almost glossy appearance. The addition of a coating as described below will permit the surface to achieve an excellent finish, and be a suitable surface for additional finishing that may arise in most normal kinds of building environments. The coating is also especially useful in providing a base for further finishing of, for example ceramic tiles, used in shower stalls, or other areas of a bathroom that are expected to be exposed to flowing water streams on a regular basis. A finish of this level of smoothness is typically achieved by using manual labor to apply a skim coating gypsum compound to a paper faced gypsum board after the paper faced gypsum board has been installed to a wall assembly. It is a highly desirable surface feature that offers a non-blemished smooth wall appearance for normal priming and painting. In this invention, and for use on the enhanced glass reinforced gypsum board manufacturing, as the gypsum surface is modified with an entrained polymer compound, because the surface is of Level 5 finish smoothness, there is no need for the priming step prior to painting as the entrained polymer also acts to serve the intended purpose of the standard priming step during a paint finishing procedure. For example, such a surface may be directly painted thereon, without need of a primer or other prefinishing step. Moreover, if a coating is applied by the coating process according to the present invention, painting and other finishing steps may be totally dispensed with on the job site, but in any case, additional finishing steps are made easier when being applied to a gypsum board product with coatings when applied according to the present invention.

With the exception of the preferred coating processes described below, the remaining process steps for completing processing of the gypsum board are considered essentially standard and are not described in detail herein. The belt line 180 removes the production gypsum board from the board production station 110, at the rate of 45 meters (150 feet) per minute, or even higher. The amount of time that is necessary for gypsum to set in a hydration process is known, and because the board must be supported by a horizontally extending surface during initial hydration, it cannot be removed from the belt line 180 or from some other horizontal supporting mechanism. Previous production rates of gypsum board produced by prior art processes were significantly slower than that produced by the present inventive production process. Consequently, the speed of the belt line was much slower.

To accommodate the significantly faster production rate of the present inventive process, the belt line 180 should be significantly longer than for the prior art production line, perhaps extending for over 180 meters (600 feet) or more.

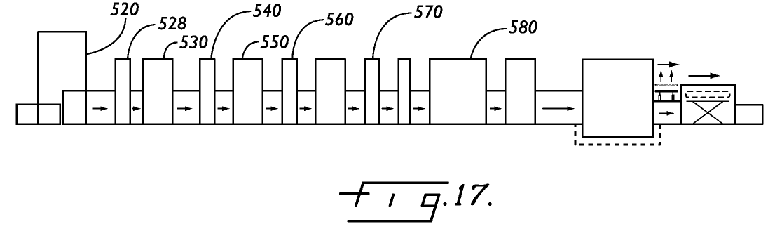

The coating process for the first or primary coating may be performed on-line or in the board formation line 180. However, to provide added flexibility in the subsequent coating processes it is preferred to use an off-line process for the second and additional coatings, as shown in the partially extended separated view of FIG. 16. In FIG. 16, the parts of the off-line transport mechanism are cut away for convenience in illustration. The actual rate of hydration is dependent on ambient conditions, such as temperature, humidity, gypsum consistency, etc. If necessary, the rate of production and speed of the belt line 180 may be modified to take into account those conditions to achieve complete hydration prior to the subsequent production steps.

Following the hydration step, the gypsum board is cut to desired lengths to produce gypsum board segments which are then turned over by turner arms and replaced onto transfer belts. Spray coating or painting of the top surface of the boards, after they are turned over, is appropriate at this stage. The boards are then transferred by a roller table (not shown) into a dryer, which process essentially may be performed by standard or known board drying procedures. The hydration process results in separating the water, which is in solution with the gypsum in the set slurry state, and further hardens to completely set the gypsum in the final gypsum board product, and the drying process removes the excess water.

The drying process removes the water from the hydrated wet gypsum by means of passing the gypsum board segments through one or more dryer sections that vary the temperature through a number of different settings. It has been found that use of mineral fibers, such as glass fibers, for the backing mat in the front and back faces permits lower temperatures to be used, and the lower temperatures, together with the absence of standard paper backing in the gypsum board, reduces the amount of drying energy needed for this portion of the process.

Final board finishing steps are also eliminated by the inventive process, which steps are presently performed in standard glass reinforced gypsum board production. For example, the creasing wheels of the present inventive production line consistently produce a gypsum board having a desired width when the creases are folded over the joined top and bottom sheets, as explained above. Thus the need to saw the board's longitudinal edges to provide a consistent width of the gypsum board segments is eliminated.

Additional benefits derive from use of the inventive gypsum board production. The production line, as configured, can be quickly and easily converted from production of paper board to that of glass reinforced gypsum board, and vice versa, thus reducing retooling expenses and downtime during conversion from one to another production mode. This can be done without stopping the production line. The higher line speed allowed by the inventive production process reduces the overall costs of manufacturing by reducing the fixed costs relative to gypsum board output, thereby increasing marginal profits.

The process utilizes a denser gypsum mixture for the front and the back and the lateral end surfaces to provide structural strength and a lighter, lower density core, which results in an overall reduction in the weight of the board, as well as a reduction in the marginal manufacturing costs. Delivery costs can also be reduced without exceeding maximum transport weight limits set by governmental regulatory agencies. Handling at a construction site is much easier, since no uncovered glass-fibers are exposed that may penetrate the skin of the workers using the board and thereby inhibits worker's physical discomfort. Another structural benefit results from the ability of forming the edges without cutting, again eliminating exposed glass fibers and further strengthening the structural integrity of the final gypsum board segments.

An additional benefit and improved performance characteristics derive from the ability to include additives into one or more of gypsum slurries 38, 44, 138. For example, if an improvement in the water-resistance of the front face or back face surfaces of the board is desired, an additive, such as a polymeric compound, may be included in the mixture of constituents input directly into the controller 36 and/or 136. Such additives may be selected to provide any of a number of desired characteristics, such as water resistance, structural strength, ability to provide an applied finishing system substrate for further finishing of the front face, including attachment of finishing elements thereto, for example, stucco wall-covering, etc.

It has been found and it is a feature of this invention that addition of a specific group of polymer additives, when mixed into the dense slurry 38, provides a number of the characteristics that provide the defined advantages. The solid polymeric compounds are dissolved in water in almost any desirable proportion, but preferable is a solution of about a 45% polymeric solids content diluted in water. In a preferred embodiment, the polymeric solution is pumped to the predetermined controller(s), for example controllers 36, 136, and added to the mixture of dense slurry 38, 138 mixed in each chamber of mixer 30. The dense slurry controllers 36, 136 then supply the dense slurry 38, 138 through outlets 34, 134 directly to the applicator roll coater wheels 22, 22′ as needed, to provide an increased physical surface strength to the completed gypsum board, so as to significantly exceed standard board specifications.

Ideally, the polymer additive in the gypsum slurry solution enhances the bonding strength also between the core slurry 44 and the outer surface dense slurries 38, 138 and between the dense slurry that extends across and through the mats of the glass fiber embedded sheets 14 and 114′. The polymer is thought to generate a polymer matrix comprising essentially physical connections resulting from the long polymer chains. The polymer matrix essentially extends from the junction of the lower density core slurry and into the dense slurry layers 38, 138, which have penetrated through the sheets 14, 114, and to extend to the surface of the gypsum board. The polymer matrix is effectively embedded within the gypsum base and provides a coalescing surface upon which further finishing can be based, for example, painting or a water impervious acrylic cover, which may be added at this stage of the finishing process, for example, by spray coating.

Preferable additives that have been found to provide the best characteristics for rugged coatings that will retain their integrity include functionalized styrene butadiene copolymers, and especially functionalized styrene butadiene copolymers that are stable in a high calcium environment.

The surface texture of the front face of the completed gypsum board includes the polymer, which, as a part of the underlying matrix, presents a smooth dense layer of gypsum to which other polymeric, e.g., acrylic, compounds can adhere. As the polymer layer cures, for example, in the drying process, it hardens to provide a stiff surface capable of retaining a load. The surface having the polymer additive, reduces chalking, improves water resistance and provides specific sites for chemical adhesion by other polymers. The composition of a water resistant or impervious coating can comprise one or a combination of the following polymeric compounds: polyacrylamide, polymethylacrylamide, polyvinyidene chloride (PVDC), polyamide (Nylon®), poly (hexamethylene adipamide), polyvinylchloride (PVC), polyethylene, cellulose acetate, polyisobutylene (Butyl Rubber®), polycarbonate, polypropylene, polystyrene, styrene, butadiene, styrene butadiene copolymer, polychloroprene (Neoprene®), tetrafluoroethylene fluorocarbon, fluorinated ethylene propylene (Teflon®), natural rubber, poly (2,6 dimethyl pentene oxide), poly 4, methyl pentene-1 and polydimethyl siloxane.

Before the drying step, when the gypsum board has not yet been cured, an optional acrylic coating step may be performed at an appropriate point in the production line. The acrylic application step may include application of an acrylic coating, by flood coating or other appropriate means, over the uncured polymer layer. The characteristics of the acrylic polymer tend to generate chemical bonds directly between the acrylic coating and the latex polymer additive embedded in the gypsum board surface. Alternatively, the acrylic coating may be applied after cutting of the gypsum board into the final board product lengths, and after the board segments are turned over to receive the acrylic coating.

The acrylic coating ideally keys into the surface layer, creating a temporary mechanical bond on the front face. Subsequent drying and curing of the gypsum board surface in a conventional dryer, including the acrylic coating, generates a chemical bond between the polymer matrix and the acrylic front face coating. The copolymeric chemical bond thus formed inhibits water absorption by the GRG board product, and further inhibits peeling of the surface layers of the gypsum board during subsequent handling of the board and during subsequent weathering of the board during its use in construction.

Preferably, the polymer additive which has been noted as producing the desired characteristics of providing a root for further chemical bonding comprises one or more polymer constituents taken from a group consisting of acrylic, styrene, butadiene, latex, or polyvinyl acetate polymers and copolymers that are dissoluble in water, such as those listed above. The delivery of the polymer in solution may be targeted into the complete slurry mix, including dense and core slurries, or may provide a targeted delivery to the dense slurry controllers, either 36 or both 36 and 136, or may even be directly targeted into the outlet 34 which delivers dense slurry 38 to the front face sheet 14. Addition of polymer, especially at strong concentrations, may affect the fluidity of the gypsum slurry, and thus, additional water and or a retarder may be necessary for use with the polymer additive, or later in the processing as needed, for example, after the slurry/polymer combination has been mixed.

Preferably, the polymer is in solution with the water and can be in a range of from about 1% to about 99% solution, but a preferable range is from about 40% to 50% polymer, and most preferably is about 45% polymer by weight. Preferably, the polymer solution is pumped into the controllers for delivering gypsum slurry to the front and back face sheets 14, 114′ at a supply rate between about 190 cm³ (0.05 gallons) per minute to about 0.019 m³ (5.0 gallons) per minute and a preferred rate of between 379 cm³ (0.1 gallons) to 0.004 m³ (1.0 gallons) per minute. The actual delivery rate may vary depending on the speed of the board production line and other manufacturing considerations. Preferably, a minimum amount of polymer additive should be entertained in the dense slurry layer, to provide a sufficient foundation for the cross-linking or composite formation, as explained below, between the coating and the entrained polymer additive. Using the above parameters as a guide, it is preferable that a minimum of 0.18 grams per square foot and a maximum of about 1.8 gallons per square foot be used as a the basis for the calculated amount of additives to the dense slurry layer. The following table also provides some guidance to the amount of additive to be entrained, depending on the application and desired characteristics:

| | Target Application Rates | | | | |
|---|---|---|---|---|---|
| Usage Rates (gal/min) | 0.05/min | 0.10/min | 0.5/min | 1.0/min | 5.0/min |
| Polymer Percent Solids | 0.45 | 0.45 | 0.45 | 0.45 | 0.45 |
| Line Speed fpm | 125 | 125 | 125 | 125 | 125 |
| Board width | 48 | 48 | 48 | 48 | 48 |
| Belt Factor (min/msf) | 0.5 | 0.5 | 0.5 | 0.5 | 0.5 |
| Belt Factor (msf/min) | 2 | 2 | 2 | 2 | 2 |
| Polymer Delivery Rate (gal/min) | 0.05 | 0.1 | 0.5 | 1 | 5 |
| Weight per gallon (liquid) | 8 | 8 | 8 | 8 | 8 |
| Board weight lbs/msf | 2000 | 2000 | 2000 | 2000 | 2000 |
| Polymer gallon per msf | 0.1 | 0.2 | 1 | 2 | 10 |
| Polymer lbs/min wet | 0.4 | 0.8 | 4 | 8 | 40 |
| Polymer lbs/min dry | 0.18 | 0.36 | 1.8 | 3.6 | 18 |
| Polymer lbs/msf dry | 0.36 | 0.72 | 3.6 | 7.2 | 36 |
| Polymer Percent Dry Solids per msf | 0.018 | 0.036 | 0.180 | 0.360 | 1.800 |
| Parts per Million | 180 | 360 | 1800 | 3600 | 18000 |

The surface acrylic coating is preferably applied to the front board face directly onto the smooth or textured surface at a rate that results in a thickness in the final gypsum board product, also referred to as the dry coverage thickness, in a range from about 0.5 mils. to about 4.0 mils. The application rate measured by weight of the wet acrylic solution per unit area of the board surface covered can be in a range of from 0.0054 grams/cm² (0.18 oz. per square foot (oz./sf)) to about 0.045 grams/cm² (1.45 ozs./sf). Ideally, the acrylic coating may comprise at least in a portion thereof one or more rheology modifying compounds that assist the coating in striking into the front face surface layer.

The acrylic surface coating may comprise any of a variety of acrylic polymer resins having a glass transition temperature (T_{g}) that is in a range of from about 15° C. to about 50° C. and preferably from about 20° C. to about 30° C., for example, those surface coating materials set forth above. Of course, other coatings besides acrylics can be used, including ones that are described in greater detail below in accordance with the present invention.

The combination of polymers and acrylic coatings used preferably can produce a monomer, such as methyl acetate, ethyl acetate, butyl acetate, or a combination thereof. A desirable minimum film formation temperature of about 15° C. to about 30° C. has been established from use of ethyl acetate monomers or a combination of monomers comprising methyl acetate and butyl acetate. Of course, the type of monomer that is formed is dependent on the interaction that occurs in the reaction during curing between the polymer additive and the acrylic coating.

The acrylic (or other copolymer) surface coating may be added well after the gypsum board has been completed, that is, after the gypsum board has been cured and dried, or even after the gypsum board is in an installed state at the work site, since the underlining matrix of dense gypsum and additive material provides a good bonding surface for the copolymer surface layer.

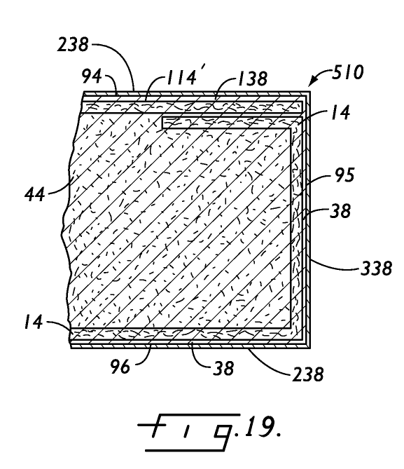

For added bonding strength between the polymer additives and the copolymer surface layer, it is possible to apply the co-polymer surface layer, for example, and the overlying acrylic layer, either before or during the curing process. Application of the copolymer layer prior to the completion of curing of the bonds formed between the polymer additive and the acrylic permits the number of such bonds to be multiplied. These bonds are maintained and strengthened during the curing process since the polymers are cured together to produce a physical, as well as chemical bond, and thus result in a stronger and more durable surface coating in the final gypsum board product. However, the coating manufacturing processes are more flexible and provide a more versatile coating manufacturing system, with respect to space and temporal considerations, and with regard to the variety and robustness of the coatings produced. These methods are described in greater detail below, with reference to FIGS. 16-18 as they are used to produce products, such as gypsum board 510 shown in cross-section in FIG. 19.

Referring again to FIG. 7, a completed inventive gypsum board product 190, manufactured according to the process of the parent application, is illustrated in partial cross-section. In the gypsum board product 190, a core slurry 44 is essentially encased in a sheath comprising a glass mat face sheet 14, folded over the longitudinal board edge, sometime referred to herein as a “machine edge”, and by the top (back) embedded sheet 114′, disposed over the hydrated core slurry 44 and the folded over edge of embedded sheet 14 that is disposed on the top surface, as shown. Dense slurry 38 and 138 are disposed over the entire outer surface of the glass fiber embedded sheets 14 and 114′ so that a minimal amount, if any, glass fibers are exposed at the surface. The inventive process provides for corners at the longitudinal edges 95, one of the machine edges being shown in FIG. 7. Alternative embodiments of the machine edges are possible, as described in the parent application Ser. Nos. 11/078,518 and 10/164,108, now U.S. Pat. No. 6,866,492, both of which are incorporated herein by reference.

An alternative to the wet board acrylic coating processes, described above, is the “dry” coating of one or both of the surfaces of the cured and dried gypsum board 190. The coating is applied after the oven-drying process and after completion of the board manufacture, thus the designation as a “dry coating” process, despite the coating being applied as a liquid which is then also dried. In a preferred embodiment of the invention, the acrylic coating process after completion of board manufacture is done “off-line,” that is, in a separate process that directs finished gypsum board products that require the acrylic coating toward a portion of the manufacturing facility that is dedicated to the acrylic coating process. Additionally, because the coating process may be required to proceed at a slower production rate, more than one acrylic coating stations may be provided, so that the simultaneous coating process may be completed in the same run as the manufacturing of the gypsum boards 190. In another optional and versatile contingency, the board may be coated “off-site” that is the coating process may proceed days or even weeks after the boards 190 have been completed. This option can be utilized to provide customized coatings to boards as needed at a gypsum board distribution center, rather than requiring the board manufacture to be completed at the board manufacturing facility.

Moreover, the acrylic or other coating applied on the surface of a glass reinforced gypsum board, either those made using processes and having a structure in accordance with the parent patented inventions, for example, in aforementioned U.S. Pat. Nos. 6,524,679 and 6,866,492, or in accordance with other known processes, for example, gypsum boards in which the additive polymeric materials may be entrained in all the gypsum slurry without a targeting of the surface layers. The present invention is utilizable with any gypsum board that has sufficient polymeric additive in the exposed surface that can provide a chemical hook or active site so that the acrylic or other finishing coating, usually a non-polar polymeric material, can bind onto the active site. It is even possible that if a polymeric additive can be provided on a surface layer of a paper faced board (not shown), the active site can be used to provide a root or foundation for a finishing material to bond.

The coating process is performed by using a roller coater according to the present invention with a polymeric, preferably acrylic, coating as described to achieve unparalleled results and to produce finished board products having physical properties that will withstand water vapor and other detrimental effects from wet environments to which a gypsum board may be exposed. It has been found that coating a layer of a first material to the coated gypsum board surface(s) after it has been cured and dried, if the conditions are controlled, can provide a much better, more durable coating on one or both of the surfaces 94, 96 of a gypsum board, for example, board 190 shown in FIG. 7. Such coatings provide a strong bond to the surfaces of the board so that they can be considered to be integral with the board.

To produce such coatings under the desirable and preferred conditions, additional equipment and additional process steps are required to the manufacturing process beyond those that are described an illustrated in the aforementioned parent application Ser. Nos. 11/078,518 and U.S. Pat. Nos. 6,524,679 and 6,866,492. However, as a result of the present invention a marked improvement in the surface coatings is possible such that the gypsum board surface experiences a significant and unexpected increase in its ability to repel water moisture and to retain the core gypsum layers dry in all kinds of moist or wet environments. One significant feature of the present invention is the ability to provide a platform for adhering of finishing features that can be applied directly onto gypsum board made in accordance with the present invention, and increase the economic advantages produced thereby by reducing the final manufacturing costs so that intermediate steps or materials are not necessary to the process.

Products that the improved coated glass reinforce gypsum boards can enable as a platform include single or multi-laminate or composite board materials, which coating laminations and composite layers can have desired characteristics for specific uses. Among these characteristics are lower polymeric densities, water resistance, heat transfer resistance, robust adhesive properties, and long term integrity, each of which characteristics can be achieved by modifying the surface coatings.

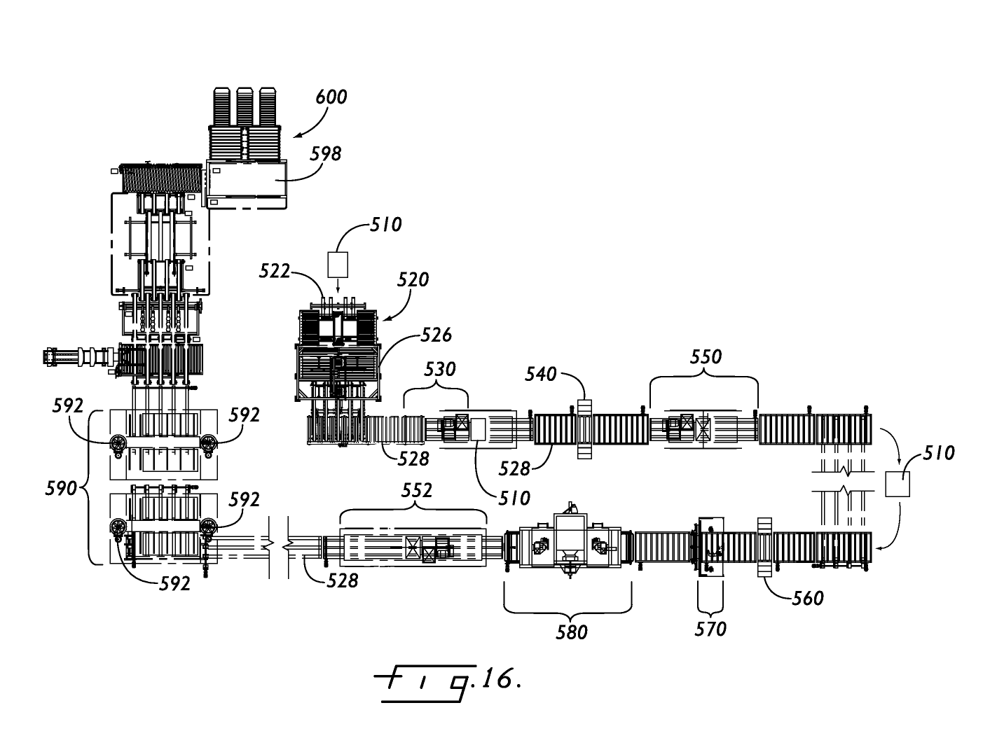

For purposes of illustration and economy in description, the similar or like elements will be identified with the identical numerals as in the previous views of FIGS. 1-15, above. That is, although the preferred embodiments of the gypsum board line and process of manufacture, including apparatus, may take the form as described above herein, it is equally possible to use gypsum board made in accordance with other processes. For example, the present method can be also used with boards made in accordance with aforementioned and commonly owned U.S. Pat. No. 4,378,405 to Pilgrim or shown and described in other like teachings which provide gypsum boards having a polymeric additive entrained in surface layers. However, to maintain the advantages and goals of the present invention, that is speed in manufacture while reducing manufacturing costs and steps in the finishing processes, those skilled in the art will recognize that the preferred methods and products described above will be most suitable for use with the present invention.

Referring now to FIGS. 16 and 17, these two illustrations are related in that FIG. 16 shows a plan view of the preferred acrylic broken out coating line 500, in which each of the separate stations are shown in an essentially schematic format in FIG. 17. Thus, these two drawing figures can be discussed together because of their mutual relation to the different steps (shown in FIG. 17) as these relate to the stations (shown in FIG. 17) where the steps are performed. It should be understood that the portions of the coating line 500 may be omitted from FIG. 16 since the complete line 500 may be very long, or may include other configurations and permutations and combinations of the elements illustrated and described. The sections and elements shown and described are the best mode of practicing the invention, but alterations and changes, for example, to fit the space allotted to the coating processes or to simplify the steps, are to be understood as being within the disclosure of the invention herein.

Referring now to FIGS. 16 and 17, the coating line 500 is described in greater detail. The gypsum boards 510 are brought from a stacked storage location, and are delivered to the coating line system 500. The boards are then unstacked at an unstacking station 520, which operation may be manual or automated. The boards 510 are fed, one at a time, into the board infeed 522 at the unstacking station 520 in the direction of the arrow, as shown.

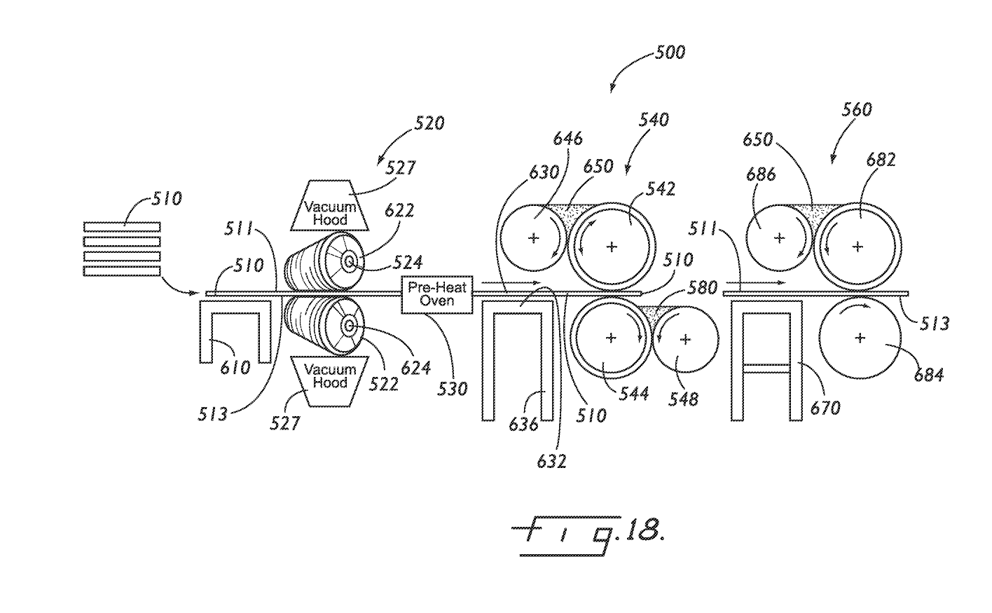

At the unstacking station 520, the boards 510 are subjected to a strong vacuum at a vacuum 526 where the boards 510 are air scrubbed to remove any dust or loose particles that may be present on the surfaces of the board 510. Following the vacuuming step at vacuum 526, the boards 510 are transported by a conveyor mechanism 528 to a preheating oven 530, where the temperatures of the boards 510 are brought up to a level conducive for providing a heated adhesive coating, in a range of from 75 to 200° F. The boards 510 continue along the conveyor mechanism 528 until they arrive at a first roll coater 540. The roll coater 540 is shown and described in greater detail with reference to FIG. 18 below.

It should be noted that the conveyor mechanism 528 between different stations in the coating line system 500 is shown essentially in an approximate manner, and it should be understood that changes or alterations to the number and order of the operational stations, e.g., vacuum 526, roll coater 540, etc. are possible, and indeed necessary, when the configuration of the line system 500 is constrained by available space or dictated by the type and characteristics' of the desired coatings. Accordingly, coating line system may include long portions of the conveyor mechanism 528, for example, that are not shown, or shown as separated by broken elements. Alternatively, for longer sections of the line between the stations, a rubberized belt, similar to that of the gypsum board formation line (FIG. 1) may be utilized in the coating process for transporting the gypsum boards 510, for example, between the roller coaters and the ovens.

Referring again to FIGS. 16 and 17, the boards 510 continue to be transported by the conveyor mechanism 528 (or other conveying means) along the coating line 500 to the next operational station, a drying or cure oven 550. The cure oven 550 cures the first coating applied onto the surface, e.g., surface 38 (FIG. 1), so that the surface includes a first coating layer 238 (FIG. 19). The coating layer(s) 238 can then be utilized as a base for one or more additional coating layers (not shown) that are, for example, applied onto the surface of coating 238 so that lamination of the coatings are provided that can take different applications and uses.

Such secondary coatings may be applied after the curing process is complete in cure oven 550, and the coated gypsum boards 510 are transported to the next station, a second roller coater 560. A second coating process can then be applied on one or both surfaces 238, 338 of the board 510. The second coating will also require curing in a cure oven, for example, similar to the cure oven 550, to cure the coating before the next step in the coating process. Alternatively, a vertical roll coater 570 is provided to coat the edges further along the coating line, as shown, to coat the edges of the boards 510. Ideally, both the machine edges, one machine edge 95 being shown in FIG. 19 with a coating 338, and the cut edges at the ends of the boards 510 are all coated in the vertical coater(s) 570. Then the boards are cured in a second curing oven 580, as shown.

The curing oven 580 may be a High Velocity Hot Air (HVHA) oven and the dwell time of the boards in the oven 580 may be limited to about 10 seconds, which is sufficient to complete the curing process at the high temperatures produced in the oven(s), after which the boards 510 pass through a final curing oven 552, that cures the coatings which oven is utilized to complete a slower cure at lower temperatures and over a longer time period. The boards 510 may then be transported over a longer stretch of the conveyor mechanism 528 to a forced air cooling station 590, comprising a plurality of wheels or fans 592, which cool off the boards at an accelerated pace to harden the coatings 238, 338, etc., suddenly and thereby forming more rugged crystalline coating structures that can withstand the elements and moisture content of the environment. Following the cooling station 590, the boards are taken off the coating line 500 at a take-off station 598 and stacked again in either a shelf system for continued long term curing or in ready-to-transport stacks 600 ready for pickup and transport of the coated gypsum board 510 to an appropriate distribution center.

The gypsum coating line 500 shown in the drawings (FIGS. 16-18) are not to scale, and it should be appreciated that the boards 510 can be manipulated between combinations of roll coater configurations as explained. That is the order and timing of the roller coaters 540 560, 570, ovens 530, 550, 552, 580, can be rearranged to fit or accommodate the layout possible in a plant of coating facility, and need not take the specific configuration shown in FIGS. 16-18.

Referring now to FIG. 18, a more detailed configuration of the roller coater and other elements of the line 500 are shown. Boards 510, stacked in an infeed stack are fed one at a time over an infeed table 610 into the vacuum station 520, comprising a brush mechanism, preferably having brushes 522 with bristles 524 each rotating around a spindle 526. The spindles 526 are mounted by an appropriate mounting means above and below the horizontal plane through which the boards 510 pass, and the bristles 524 are long enough to reach from the spindle 526 to the surface of the boards 510.

As the boards pass through the vacuum station 520, the bristles 524 brush off any loose or unwanted surface dust or imperfections that may have developed in the manufacturing process and subsequent treatment of each board 510. Removal of any dust and other loose material so it does not reattach itself to the surface of a board 510 is achieved by a pair of vacuum hoods 527, each disposed around one of the brushes 522. The vacuum hoods 527 provide air suction that removes and filters out any dust or other particulates from the board environment. The boards 510 are then passed through a pre-heat oven 530 to a second intermediate table 630, from which they begin the coating process. Although tables 610, 630 are shown in FIG. 18, and a conveyor mechanism 528 is shown in FIG. 16, these are not significant, and can be considered as alternatives for transporting of the boards 510 through the gypsum board coating line 500.

As the boards 510 pass over the upper surface 632 of table 630, or over the conveyor mechanism 528 (FIG. 16), the leading edge 512 of each board is engaged by a first roll coater configuration 540, which may be a double coater configuration, that is, the roll coater combination is a double roll coater 540 that coats each board 510 on the top and bottom surfaces as it passes through the coater configuration 540. Board 510 is pulled through the coater configuration 540 by a squeezing action on the board 510 by and between the two pliable rollers 542, 544 that are rotating and counter-rotating in opposite directions, but both rotating so that when in contact with the board 510, they are rotating in the direction of motion of the board 510 through the line 500. As the leading edge 512 of each board engages the rollers 542, 544, the friction of the rollers grabs the board edge 512 and the roller rotation pulls the board 510 through the first coater combination 540, as shown in FIG. 18. Simultaneously, the board surface is coated by coating materials that are present on the surfaces of the coater rollers 542, 544, and which are applied by applicator rollers 542, 544. As is shown in FIG. 18, the coating materials associated with the roll coater top and bottom applicator rollers may be different, the roller 542 applying one material 650 while the applicator roller 544 may apply a different coating material 580. Of course, the materials 650, 580 may be the same.

Preferably, the coaters 540, and also 560, 570, 580 comprise soft material, sometimes described as a soft sponge roll coater, instead of a hard coater. That is, the hardness of stainless steel coater wheels are about 100 on a Durometer scale for a standard coating operation, the Durometer scale hardness for a coater applicator wheel 542 of the present invention is in the range of from about 10 to about 30. The applicator wheels, e.g., wheel 542 are configured to rotate in the direction of travel of the board 510 to apply the coating evenly. The coating material may be heated. The resulting coating 238 (FIG. 19) is achieved to a wet coating thickness of about 16 grams per square foot, and reduces to a thickness of about 2.55 mil when dry. Secondary coating wet thickness of the subsequent coating operations at roll coaters 560, 570 may be about 20 grams/sq. ft.

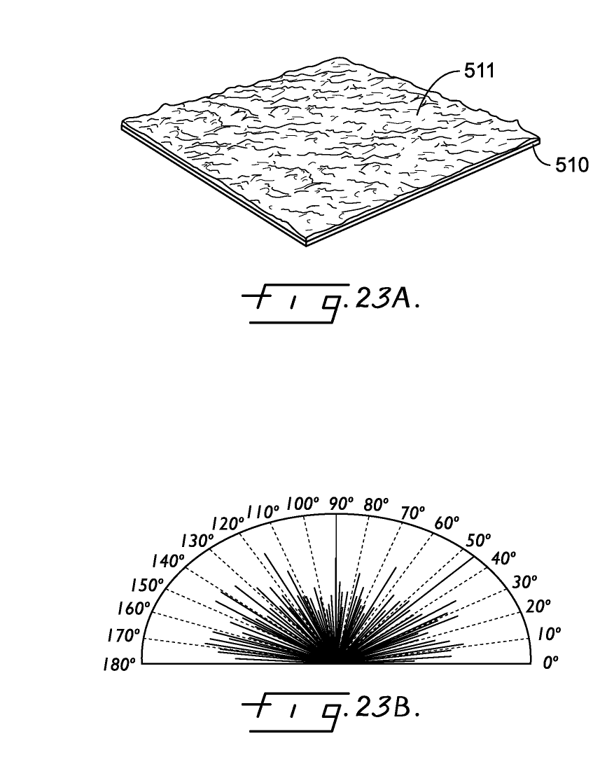

The inventive coating processes provide additional features that modify the topology of the board surfaces 511, 513 (FIG. 23 A, not to scale) with a hydrophobic secondary coatings, for example, wax emulsions, and other polymers, that are deposited on top of the acrylic or polymeric coating 238, 338 in subsequent coating operations at roller coater stations 560, 570, 580 etc. so as to result in a surface tension that increases to wetting by water to permit good adhesive properties resulting in good mastic and mortar adhesion properties, while simultaneously providing an almost moisture proof impermeable surface in the underlying acrylic coating 238.

Additionally, the ability to have a number of coatings applied sequentially with various properties modifications provided by filler materials, such as silica or microscopic organic matter, in the context of a surface for adhesion of tiles, provides a good water resistant board that is capable of holding to a greater degree the tiles and other finishing materials that can be used to finish the interior wet walls of a building.

The types of coatings that are possible to be added, in one or multiple layers, with or without laminations include most known coatings, such as wax, acrylic, polymeric coatings, or virtually any coating material that can be applied with a roller coater application. Among the known coatings that are contemplated for bonding to the polymer additives that are set forth in the grandparent of the present invention, now U.S. Pat. No. 6,524,679 are: Polymers, amorphous crystalline, or semi crystalline thermoplastics, thermoset rubbers and elastomers, thermoplastic elastomers, and rigid thermoset polymers.

To facilitate stronger chemical bonding between the additive and the first coating material, it is desirable to use an additive that is effective in providing a viable root or the foundation to which the first coating material can attach. It is considered that an appropriately modified additive material will assist in providing a cross-linking capability. Appropriate modification of effective portions of standard additive materials in order to provide a functional active group for the first coating material to bond to is possible. The additive can even be customized, depending on the type and characteristics of the coating material that will be applied. For example, one particular and promising polymer additive that has tested well in preliminary testing for creating a cross-linking capability to most coatings is a functionalized Styrene Butadiene (SBD) Latex, sometimes referred to as Styrene Butadiene Rubber (SBR), available commercially from Omnova Solutions, Inc. of Mogadore, Ohio. It is believed that the functionalized SBD is capable of providing bonds to the polymeric additive in the enhanced dense gypsum layer by forming covalent, allyl, Vanderwal, single or double bonds.

Among the known coatings that are contemplated for bonding to the polymer additives that are set forth in the grandparent of the present invention, now U.S. Pat. No. 6,524,679 are polymers, amorphous crystalline, or semi crystalline thermoplastics, thermoset rubbers and elastomers, thermoplastic elastomers, and rigid thermoset polymers.

The polymer types that can be used for such coatings are varied, and include ABS Acrylonitrile-BDS; acrylics; cellulose; alternating, block, periodic, random, or statistical copolymers; Epoxy resins; Fluoropolymers; Polyamide; Polyaniline; Polycarbonate; Polyester; Polyethylene; Polymerization Polyolefins; Polypropylene; Polystyrene; Polythiophene; Polyurethanes; Polyvinyl acetate; Polyvinyl alcohol; Polyvinyl chloride and Silicones.

Particular coatings are considered to be promising as coatings comprise specific materials such as allyl resins; thermoset polycondensates; cellulosic thermoplastic modified natural polymers; epoxies, such as Thermoset polyadduct; Ethylene vinyl alcohol, (ENVAL); Fluoroplastics such as PTFE, FEP, PFA, CTFE, ECTFE, ETFE); Ionomers; Liquid Crystal Polymer, (LCP); Melamine formaldehyde, (MF); Phenol-formaldehyde Plastic, (PF), (Phenolic); Polyacetal, (Acetal); Polyacrylates, (Acrylic); Acrylonitriles, such as Polyacrylonitrile (PAN); Polyamide, (PA), (Nylon®); Polyamide-imide, (PAI); Ketones, such as Polyaryletherketone (PAEK), Polyektone, (PK), Polyetheretherketone, (PEEK); Polybutadiene, (PBD) Polybutylene, (PB) Polycarbonate, (PC); Polydicyclopentadiene, (PDCP); Polyesters; Polyetherimide, (PEI); Polyethersulfone, (PES); Polyethylene, (PE); Polyethylenechlorinates, (PEC); Polyimide, (PI); Polymethylpentene, (PMP); Polyphenylene Oxide, (PPO); Polyphenylene Sulfide, (PPS); Polyphthalamide, (PTA); Polypropylene, (PP); Polystyrene, (PS); Polysulfone, (PSU); Polyurethane, (PU); Polyvinylchloride, (PVC); Polyvinylidene Chloride, (PVDC); and Thermoplastic elastomers.

It is also contemplated that one or more of the above coatings may include additives that are fillers or property modifiers that provide desirable characteristics or properties to the coatings and boards. For example, such modifications may provide properties such as flame retardant, density modified, sound attenuation, strength modification, and weather stabilization properties to the boards which can then be used for different and specified applications. Other modifying agents may change the surface texture characteristics of the board surface.

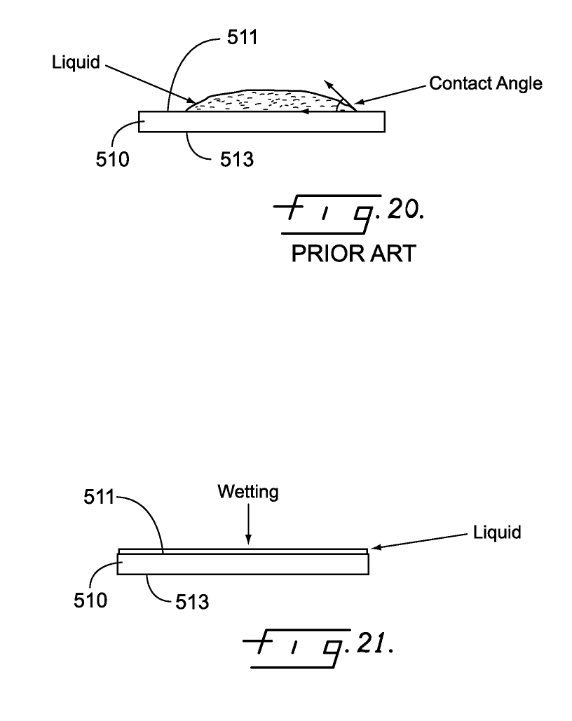

The coatings also are capable of providing a good base for adhesion of mastic and mortar, especially with the addition of surface texture modifying agents, for example, preferably polypropylene beads. Other types of additive materials that have been noted in providing the desired properties may include silica, such as sand particles, fly ash, calcium oxide, polyethylene, or any filler that has a size that is controlled within a range. In terms of surface wetness, reference is made to FIGS. 20 and 21, which show the difference in surface tension, and thus surface wetting of a water, on the surface of prior art boards 810, shown in FIG. 20 and of boards 510 made in accordance with the processes and additive combinations of the present invention. As can be seen in FIG. 20, the prior art gypsum board 810 shows a liquid wetness that is less than optimal, and has a contact angle of almost 45°. In contradistinction, the corresponding contact angle of the inventive board 510 is minimal or non-existent, as shown in FIG. 21, the surface 511 of the board 510 being completely wetted by the liquid thereon.

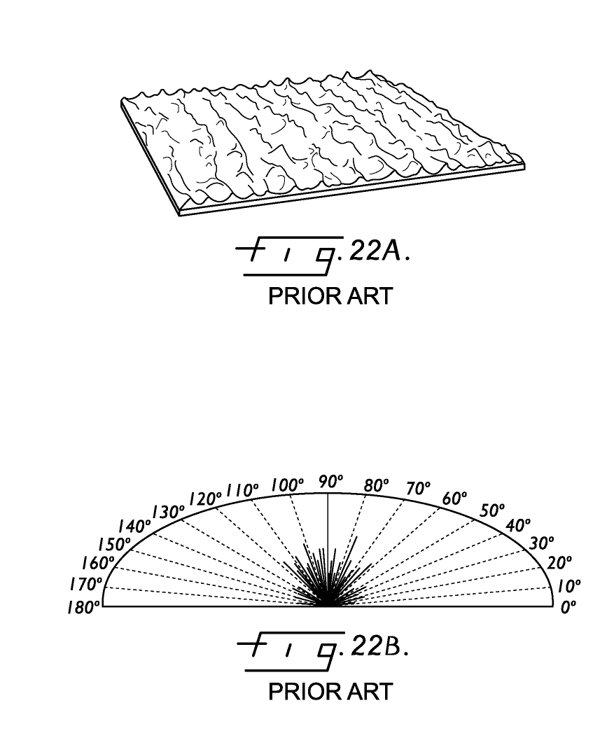

FIGS. 22A and 23A show the difference in surface texture, allowing for better adhesion to finishing materials, between prior art tile backer boards 810 (FIG. 20) and the inventive boards 510 (FIG. 21) coated with the novel methods and materials, respectively. FIGS. 22B and 23B show the difference in the reflective properties of the film, as tested, between prior art tile backer boards 810 (FIG. 20) and the inventive boards 510 (FIG. 21), respectively. The reflective properties, i.e., specular reflection off the surfaces of the respective boards 810, 510 show the dramatic increase in the range and intensity of reflection from a surface 511 that has been wetted, and which itself is an indication of the surface texture and the concomitant ability to provide a base for liquid adhesion of finishing materials to the surface 511, for example, mastic, mortar, polymeric adhesives, etc.

When a coating according to the present invention has been applied and creates a strong bond to the gypsum board, the top-most coating comprising another polymeric material that would not necessarily be a perfect candidate for the first surface coating 238, can serve as an additional foundation on which other coatings and/or laminates can be applied. The properties of the different layers may be made compatible to forming a strong chemical bond between the successively applied layers, so that the formation of laminates can be contemplated having strong bonding capabilities. Preliminary testing of the chemical and physical adhesive bonds formed between layers has indicated that attempts to remove the coatings or laminations from the board result in little, if any, delamination.

Preliminary testing has produced a significant increase in measured bond strength. Unconfirmed results of comparison tests against competitive products being as much have shown as much as 39% increase in average shear bond strength. Moreover, when the inventive coatings reach failure after shear tension is continually increased, the failure mode is different in kind from that of the competitive coatings. The competitive coating mode, as tested, resulted in delamination of the coating or the underlying glass mat facer layer, effectively releasing the glass facing layer from the gypsum board almost like a contact sheet. In contradistinction, the inventive coatings, due to the increased physical and chemical bonds that are achieved in the layers from the core to the surface coating, the failure mode is a co-adhesional one, that is failure occurs in the adhesive layer bonding the tile to the facing core or the substrate.

To increase the surface area that is susceptible to adhering a coating thereon, modification of the coating surface may be achieved by including any of a number of modifying agents to the coating material. For example, a significant increase in specular reflectivity of light reflected from the coated board surface 511 has been observed, which is attributed to the choppier or rougher surface texture, when the coating materials include beads or discrete particles of a predetermined size in the coating as it is deposited on the surface by the roller coater. These fractured spherical beads may be inorganic or organic fillers having a predetermined size, preferably between 160-180 microns, but having a maximum particle size of 300 microns. These may include silica, such as sand particles, fly ash, calcium oxide, polyethylene, or any filler that has a size that is controlled within a range.

Preferably, the filler comprises polypropylene beads of the predetermined size, and in a weight percent range of between 5 and 10 percent. Of course, there may be occasion to exceed these ranges in order to achieve a desirable characteristic, for example, to achieve a surface texture that is a feature of the board.

The beads are believed to impact the surface in a way that results in a rougher surface texture, and thereby provide an added amount of surface area for the subsequent second or third coatings to adhere and form both chemical and physical bonds. The test results in board integrity noted above have been achieved using less coating material to achieve stronger coatings with a decreased propensity to delaminate or otherwise fail when tile or other heavy finishing materials have been adhered thereonto when compared to competitive products.

As described herein, and in accordance with the tested phenomena and characteristics of gypsum boards made in accordance with the present invention, the gypsum boards 510 may be utilized as a smart vapor panel. Simultaneous to the vapor passage capability, the board may provide a good base on which one or more additional coatings may be applied. Such panels may be subjected to a finishing process that renders it semi-permeable when humidity is high, but relatively impermeable when relative humidity is reduced. In a more specific application of the ability to provide an environmentally directional gypsum board surface, the surface may include a surface that has characteristics that varies permeance through the surface. Permeance in this context is defined as the degree to which a material admits a flow of water vapor thorough the gypsum board surface 511.

Recent studies have shown that permeance is dependent on many factors, the significant ones being the surface characteristics and the humidity of the environment on either side of the board 510. It has been noted, and tests of the present inventive coatings have confirmed, that at low humidity (about 25%) the board 510 is essentially closed (less perms) and as the humidity increases (about 75%) the surface 511 opens up and allows water vapor to move through the surface 511. It is even possible that a surface can be developed that closes to permeance when there is liquid water, but opens for water vapor or moisture. Thus, even if an undesirable amount of moisture somehow penetrates the seal of the coating on the surface 511, the permeance at higher humidity will permit the vapor to penetrate the coating and evacuate the space behind the wet board or tile backer board in a surface.

For different uses or applications, different thicknesses of polymeric coatings may be desired. For example, for glass reinforced gypsum boards used for bath backer applications, a coating of from about 16 grams per square foot, translating to a thickness of between 2.25 to 2.75 mils, may be desired to provide a more robust, yet moisture penetrating coating that can also withstand the shear stress of the ceramic tiles producing a continual weight on the surface 511. For other uses, even a greater thickness in coating depth may be desirable.

Testing results in comparison of permeance values of gypsum boards 510 made in accordance with the teachings herein and prior art tile backer boards using a current version of ASTM Method E 96 Standard Test Methods A and B for water vapor transmission of materials, it is evident that the average perm results were comparable. Perm is the term used to indicate a value of permeance, in accordance with the standards established by Stanley D. Gatland, II, “Comparison of Water Vapor Permeance Data of Common Interior Building Materials in North America Wall Systems”, 10th Canadian Conference on Building Science and Technology Ottawa, May 2005, pp-182-194. A perm value of less than 1.0 is considered to be a material that is a vapor retarder, a perm value of between 1.0 and 10 perms is a semi-permeable material and one greater than 10 perms is a permeable material.

The test results showed that the enhanced glass reinforced gypsum boards 510 coated with one preferred embodiment acrylic coating provides a perm value of about 1.41 at a relative humidity of about 25%, and on average, the products are semi-permeable at a relative humidity of about 45% or less. Thus, the coatings applied having a good adhesive qualities to the surface of the board 510 also do not sacrifice any of the permeance values of gypsum board. Comparable green board values for permeance are over 10 as the water vapor permeability of green boards is very open.

It has been found that the inventive roller coater process used with the polymeric additive in the surface layers of a gypsum board, as described above, provides heretofore unknown flexibility and variety in new and much more easily manufactured board products that in the long run provide better and more durable products with a reduction in costs of manufacture. The unexpected characteristics in the gypsum board products obtained from the chemical bonding between the surface layer having the polymer additive entrained therein and corresponding coating compounds that can be utilized provides heretofore unknown capabilities to enable the use of such gypsum boards in new and previously unavailable applications, or if available, applications once prohibitively expensive, are now in competitive with other more expensive products. For example, when used with traditional tile backer board, i.e., the aforementioned green board, for use as a backing surface for tile finishing in shower stalls, an expensive concrete core includes a coating applied on the surface. Using the inventive structure and coating processes, tile backer can be made from glass reinforced gypsum boards, and can be as tough and water resistant as traditional green boards, but with greater water and moisture resistant properties and much decreased propensity to wick water up or through the board.

The roll coaters 640, 680, 690 and 699 are preferably Direct Roll Coaters which may be commercially available from Black Bros. Co., of Mendota, Ill., as model No. 22D-775. Optimal operating temperatures for the rollers range between 55 to about 95° F., with a preferred temperature of about 70° F. The gap between applicator roller, e.g., 542, and the doctor or metering roller (546), which can be preset, is ideally less than 0.1 inch. The speed of the applicator roll is between 0 to 500 feet per minute (fpm), with a preferred range of between 50 to about 125 fpm. The speed of the metering roller, e.g., roller 646, is between 10 to 100% of the applicator roller speed, but in most respects should be at least slightly faster to permit the coating material to be coated evenly onto the applicator roller.

It should be recognized however, that the above are only preferred ranges, and different configurations may be possible. For example, other types of roller coaters are available, either from Black Bros. Co., of Mendota, Ill., or another commercial supplier of roller coaters. These may require modification of the line and other structural details of the apparatus used to provide the desired coating characteristics. Modifications of these and the processes described above may be made without departing from the scope of the present invention. The rotational directions of the rollers are as shown by the arrows in FIG. 18.

The rotational direction for the first roller coater combination 540 is shown with a double arrow for the top roll coater 542, whereby the rotation direction can be in either a clockwise or counterclockwise direction, as desired. For example, although the roll coater rotational direction is preferred to rotate in the direction of motion of the gypsum board panel, it may be desirable to have the rotation in a counter direction to the board movement. In such a configuration, sometimes referred to as a reverse roll coater, one of the roll coaters, the top applicator roll 542 disposed above the panel 510, may rotate in the reverse direction, that is, against the forward motion of the panels 510 through the gypsum coating line 500. The reverse rotating of roll 542 will cause the roll coater to wipe the coating material 650 onto the top surface of board 510 directly, and so to apply a greater amount of coating material 650 on the board panel surface. It is considered that such a process also allows for more fill to be applied over the porous substrate of the surface of board panel 510.

Use of the inventive processes and apparatus for manufacture of the pre-coated gypsum boards provides numerous advantages. The improved manufacturing processes provides benefits in increased yield and availability of products, in the workers' ability to handle the products without the need of gloves or protection for the hands, and minimizes dust, both on the product and in entrained in the of atmosphere production space.

While this invention has been described particularly as it applies to glass reinforced gypsum board panels, the invention can also be applied to exterior sheathing building components such as cement board, plaster board, plastic, and fiberglass panels. The above-described embodiments are illustrative of this invention only and are not intended to limit the invention. Modifications and alterations of the disclosed embodiments are within the ability of persons having ordinary skill in the gypsum board, tile backer and exterior sheathing art, and this invention is not intended to be limited to the description of the disclosed embodiments, the invention being limited only by the following claims and equivalents thereof.

What is claimed is:

1. A method of finishing a gypsum board, the gypsum board having a surface gypsum layer in which a polymer additive has been entrained, comprising:
a) forming a gypsum board including the polymer additive entrained in at least one surface layer;
b) applying a primary coating to the polymer entrained surface layer;
c) curing and drying the coated gypsum board;
d) passing the coated gypsum board through a direct roll coater wherein a second coating is deposited over the at least one surface layer of the gypsum board in which the polymer additive has been entrained and the primary coating has been applied;
wherein the second coating is preselected from materials capable of providing improved water resistance, increased surface tension and a rougher surface topology.

2. The method of finishing a gypsum board according to claim 1 wherein the primary coating is applied to the polymer entrained surface layer of the gypsum board using a spray coating system; and
wherein the primary coating forms a mechanical and chemical bond to the surface layer including the polymer entrained therein.

3. The method of finishing a gypsum board according to claim 1 wherein the primary coating is applied to the polymer entrained surface layer of the gypsum board using a flood coater; and
wherein the primary coating forms a mechanical and chemical bond to the polymer entrained surface.

4. The method of finishing a gypsum board according to claim 1 further comprising passing the gypsum board through a second direct roll coater wherein a third fluid coating is deposited over the second coating;
wherein the third coating forms a chemical bond with the second coating and the second coating forms a chemical bond with the primary coating.

5. The method of finishing a gypsum board according to claim 4 wherein the bond of one coating to an adjacent coating is a bond that is selected from the group consisting of a covalent, allyl, Vanderwal, single and double bonds.

6. The method of coating a gypsum board according to claim 4 wherein the coating formed by the prior coating steps is repeated by passing the gypsum board through a third roll coater in which a fourth fluid coating is deposited over the primary, second and third coatings.

7. The method of finishing a gypsum board according to claim 4 wherein the second coating and the third fluid coating are of the same composition.

8. The method of finishing a gypsum board according to claim 4 wherein the second coating and the third fluid coating are of different compositions.

9. The method of finishing a gypsum board according to claim 1 wherein both top and bottom surfaces of the gypsum board are coated by a second coating when passing through the first roll coater.

10. The method of finishing a gypsum board according to claim 1 whereby the increased surface tension and rougher surface topology of the coating material includes applying a material that has characteristics providing a raised surface having isotropic texture area directional features, and whereby the surface contact area of the board is increased to provide an increased chemical and mechanical adhesive surface for attaching tiles thereto.

11. The method of finishing a gypsum board according to claim 1 wherein the coating is modified by using silicates or carbonate like beads as a filler thereby to provide increased surface tension and a rougher surface topology of the gypsum board surface.

12. The method of finishing a gypsum board according to claim 10 wherein the second coating is further modified by predetermined sizing of the beads, thereby to provide increased surface tension and a rougher surface topology of the gypsum board surface.

13. The method of finishing a gypsum board according to claim 10 wherein the second coating is modified by using polypropylene beads having a predetermined size thereby to provide increased surface tension and a rougher surface topology of the gypsum board surface.

14. The method of finishing a gypsum board according to claim 10 wherein the coating is further modified by providing beads comprising silicates or carbonates as a filler, thereby to provide increased surface tension and a rougher surface topology of the gypsum board surface.

15. The method of finishing a gypsum board according to claim 1 wherein passing the gypsum board through the direct roll coater further comprises passing the gypsum board through a double roll coater wherein a bottom applicator roll is in contact with the bottom surface to deposit a coating over the bottom surface layer of the gypsum board.

16. The method of finishing a gypsum board according to claim 15 wherein the double roll coater includes a top application roll rotating in a direction that is in the same direction as the board movement relative to the roll.

17. The method of finishing a gypsum board according to claim 15 wherein the double roll coater includes a top application roll rotating in a direction that is in the opposite direction as the board movement relative to the roll.

18. The method of finishing a gypsum board according to claim 1 wherein the polymer additive entrained in at least one surface layer of the gypsum board further comprises a functionalized styrene butadiene copolymer.

19. The method of finishing a gypsum board according to claim 1 wherein the polymer additive entrained in at least one surface layer of the gypsum board further comprises a functionalized styrene butadiene copolymer that is stable in a high calcium environment.

20. A coated gypsum board made in accordance with the method of claim 1.

21. A coated gypsum board, the gypsum board having a surface layer in which a polymer additive has been entrained, further comprising a primary coating that includes a chemical bond between the polymer additive entrained in the surface layer of the gypsum board and the coating material which is preselected so as to produce an increased surface tension thereby providing a raised surface having isotropic texture area directional features, whereby the surface contact area of the board is increased to provide an increased chemical and mechanical adhesive surface capable of attaching tiles.

22. The coated gypsum board in accordance with claim 21 further comprising a second coating that is chemically bonded with a polymer in the primary coating on the surface layer of the gypsum board.

23. The coated gypsum board according to claim 21 wherein the gypsum board coating materials of the second coating are preselected so as to produce an increased surface tension thereby providing a raised surface having isotropic texture area directional features, whereby the surface contact area of the gypsum board is increased to provide an increased chemical and mechanical adhesive surface for attaching tiles thereto.

24. The coated gypsum board according to claim 22 wherein the gypsum board includes a polymer additive entrained in at least one surface layer of the gypsum board wherein the polymer additive further comprises a functionalized styrene butadiene copolymer.

25. The coated gypsum board according to claim 22 wherein the gypsum board includes a polymer additive entrained in at least one surface layer of the gypsum board wherein the polymer additive further comprises a functionalized styrene butadiene copolymer that is stable in a high calcium environment.
